(19) United States
(12) Patent Application Publication
(10) Pub. No.: US 2004/0028772 A1
(43) Pub. Date: Feb. 12, 2004

(54) Method for preparation of chewing gum with customer acceptable taste

(76) Inventor: Carsten Andersen, Vejle (DK)

Correspondence Address: FOLEY AND LARDNER, SUITE 500, 3000 K STREET NW, WASHINGTON, DC, 20007, US

(21) Appl. No.: 10/344,706

(22) PCT Filed: Aug. 14, 2001
(86) PCT No.: PCT/DK01/00539

(30) Foreign Application Priority Data
Aug. 14, 2000 (DK) PA 2000 01209

(51) Int. Cl. A23G 3/30

(52) U.S. Cl. 426/3

(57) ABSTRACT

Method for preparing a chewing gum with a customer acceptable taste of an active ingredient substantially during all chewing phases.

The present invention relates to a method for preparing a chewing gum with a customer acceptable taste of an active ingredient substantially during all chewing phases, the method comprising; i) testing the taste of the active ingredient in a test system for establishing a maximal acceptable concentration (MAC) of the active ingredient in a liquid formulation; ii) measuring the release of a desired amount of an active ingredient from a standard chewing gum center formulation during chewing;

iii) establishing whether the release of ii) results in a concentration exceeding or not exceeding MAC during the chewing period and establishing the time in relation to the chewing period when the concentration is exceeding MAC or is not exceeding MAC, and

iv) adapting the chewing gum formulation to control the release of the active ingredient in the chewing period when the MAC has been exceeded and/or in the chewing period when MAC is not exceeded.

### TECHNICAL FIELD

In recent years extensive research has been carried out with respect to the use of chewing gum as a delivery system for medicines. This delivery system has proven to be particularly suitable when a local effect in the oral cavity or the pharynx is desired or when an absorption of the medicine via the mucous membrane of the mouth is required, in such cases when it is desirable to avoid the so-called “first pass” effect, that is the catabolism in the liver at the first passage, or when the medicine is sensitive to the environment in the gastrointestinal tract.

Several methods have been provided for the preparation of a chewing gum composition capable of releasing specific components in a controlled manner. Thus, a number of processes is known for obtaining an improved release of specific aroma agents and highly potent sweeteners with the purpose of prolonging the perception of taste when chewing a chewing gum.

U.S. Pat. No. 4,238,475 discloses a chewing gum comprising a water-insoluble therapeutic component which is coated with a water-soluble coating agent to prevent resorption of the therapeutic component back into the gum base. The release of the therapeutic component is, however, conditional of the coating remaining intact during chewing. As a result, the therapeutic component does not come into direct contact with the oral cavity and can therefore not be used for medicines intended to be locally effective in the oral cavity and the pharynx. Furthermore, the method for preparation is elaborate and further complicated by the fact that the coating must not be destroyed during the preparation.

EP patent application No. 227,603 discloses a chewable delivery system comprising an active agent coated with lecithin, polyoxyalkylene, glyceride etc which is then incorporated in a matrix system comprising gelatine, water and sweetener, among other things. Also, in this case the active agent passes through the oral cavity in a coated form and will therefore not produce a local effect.

EP patent application No 229,000 discloses a process and a chewing gum for the protection and controlled release of an active agent, including medicine, highly potent sweeteners and aroma agents. The active agent is provided with a hydrophobic coating using a melted blend of polyvinyl acetate and plasticizer whereupon the blend is cooled, ground, sieved and blended with usual chewing gum ingredients. It is stated that a delayed release in the order of 10 to 20 minutes can be obtained, but this does, however, not automatically result in an increase of the total quantity of substances released. The process is rather complicated and requires the active agent to be able to stand the temperatures involved in the process.

EP patent application No. 217,109 discloses a chewing gum in which prolonged and controlled release of, among other things, pharmaceutical agents, food ingredients and confectionery ingredients in multi-micro encapsulation hereof is obtained by means of, for instance, cellulose compounds, polyvinyl pyrrolidone, starch or saccharose etc. The process is, however, complicated and difficult to control.

U.S. Pat. Nos. 4,493,849 and 4,597,970 disclose that lecithin can be used in chewing gum to improve the mouthfeel of the chewing gum and to increase the moisture properties and texture.

DK patent application No. 5386183 discloses a method for obtaining longer impact times in the oral cavity when treating fungal infections in the oral cavity. This is obtained by formulating antifungally active compounds, especially imidazole and triazole derivatives, with special gel agents such as cellulose ethers, sodium alginate and propyleneglycol alginate, in order to obtain a better adhesion of the active agent to the oral cavity. It is, however, unpleasant and difficult to keep such gelatinous preparations in the mouth for long, and the impact of the active agent will vary considerably depending on how long it is kept in the mouth.

WO 97/00619 discloses the use of sucrose fatty acid esters in chewing gum. The sucrose fatty acid ester is used in the gum or gum base as a plasticizer, softener, and emulsifier. The sucrose fatty acid ester is also used as a replacement for fat, oils and emulsifiers, and it is mentioned that sucrose fatty acid esters may by used as a release agent for encapsulated flavours and as a carrier for flavour oils. The application relates to sucrose fatty acid esters as such including palmitic and stearate acids. There is no mentioning or indication that certain sucrose fatty acid esters should be superior with respect to any of the general uses of sucrose fatty acid esters disclosed therein.

### BRIEF DESCRIPTION OF THE INVENTION

It is a well-known problem in chewing gum preparation that many agents are not released completely from the chewing gum within the usual chewing period of 2 to 10 minutes. It is not unusual that the amount of an active agent released stated as a percentage of the total quantity of aroma agent added, is in the following order

After chewing for 2 minutes: 5 to 15%

After chewing for 5 minutes: 7 to 20%

After chewing for 10 minutes: 10 to 25%

The gum base of a chewing gum will normally retain a substantial part and even up to 30% of active ingredients such as pharmaceutical drugs, vitamins, and other active ingredients.

The benefit for the producer according to the present invention is therefore in addition to the improved taste sensation that less cost for the production is incurred as minor amounts of an active ingredient are needed for the same effectiveness.

Accordingly, active ingredients such as pharmaceutically active components may be effectively released in a controlled manner from the chewing gum.

In connection with the use of chewing gum as a dispensing form of medical substances, it is important that these substances are released from the chewing gum in a sufficient quantity and with the right velocity in order to reach the optimal effect.

Besides, it could be desirable to control the release of a medicinal substance of unpleasant taste in such a manner that the unpleasant taste is additionally covered by flavour components in the best way possible.

### DETAILED DESCRIPTION OF THE INVENTION

The present invention relates to a method for preparing a chewing gum with a customer acceptable taste of an active ingredient substantially during all chewing phases. This is achieved as a general method wherein the taste of the specific active ingredient or mixtures of ingredients is evaluated with respect to taste in different concentrations. Subsequently, a maximal desired or acceptable concentration is elected for the active ingredient or such concentration may be achieved by other means such as from the literature or any other information or even being a guess.

The desired amount of the active ingredient is incorporated into a standard chewing gum formulation. The standard formulation may be any chewing gum formulation known in the art or may be selected based on general knowledge in the art and with regard to specific circumstances related to the active ingredient.

The release of the active ingredient during chewing is then measured or recorded in any conventional means. This may include a test panel which collects saliva upon chewing but which is much more convenient than the use of a chewing machine with conditions imitating the normal chewing procedure or during conditions correlated to the natural chewing situation.

Accordingly, the method according to the present invention comprises

i) testing the taste of the active ingredient in a test system for establishing a maximal acceptable concentration (MAC) of the active ingredient in a preferable liquid formulation. However, if such maximal concentration is established in any other way, this will be the MAC value for the subsequent steps of the method and thereby step i) is in fact replaced with that other way. The method further includes the steps of

ii) measuring the release of a desired amount of an active ingredient from a standard chewing gum formulation during chewing and

iii) establishing whether the release of ii) results in a concentration exceeding or not exceeding MAC during the chewing period and establishing the time in relation to the chewing period when the concentration is exceeding MAC or is not exceeding MAC; subsequently iv) adapting the chewing gum formulation to control the release of the active ingredient in the one or more chewing periods when the MAC has been exceeded and/or in the chewing period when MAC is not exceeded. In this respect, the term controlled refers to establishing a concentration in a given period of the active ingredient which is closer to the maximum acceptable concentration than before the adaptation of the chewing gum formulation. Accordingly, in one embodiment control may refer to increased release in the period and in another embodiment to a decrease in the release in the period. In addition, control may also refer to a situation where after adaptation no substantial difference is established in the specific period, but the adaptation results in an alteration of the release in a prior or later period.

Accordingly, the adaptation may be performed in order to control the release of the active ingredient which results in a increase in the release of the active ingredient in the chewing period before and/or after the specific chewing period, e.g. when the MAC in the specific chewing period has been exceeded. On the other hand, the adaptation may be performed in order to control the release of the active ingredient which results in a decrease in the release of the active ingredient in the chewing period before and/or after the specific chewing period, e.g. where the MAC in the specific chewing period has not been exceeded.

The method according to the invention may be performed with only a short duration of recording of whether MAC is as desired in the period. However, to ensure an optimal taste sensation of the customer or end user it is preferred that the time in relation to the chewing period when the MAC has been exceeded or not exceeded is measured as at least as a first and second period, preferably as at least a first, second and third period. The skilled person would be able to select the relevant periods and a sufficient number of periods. Of course the method also refers to the situation where the release is measured until substantially all the active ingredient is released and a subsequent adaptation is performed based on arbitrary periods or periods are defined with respect to inter alia peak concentrations or on the configuration of the concentration curve.

In general, a first period is selected as a period within the first 10 minutes from the beginning of chewing, the second period being after the first period and within the period from 1 minutes to 20 minutes from the beginning of chewing, a possible third or further period being after the second or third period respectively, and being within the period from 3 to 90 minutes of chewing.

The periods selected for the Examples in the present invention are a first period of 2 minutes, a second period of 3 minutes and a third period starting from 5 minutes. It is generally preferred that the effective amount of the active ingredient is released within the first 30 minutes and in such cases after 15 minutes the concentration will normally decrease steadily towards zero. Accordingly, a measurement for longer than 20 minutes will seldom be necessary.

Thus, a preferred embodiment refers to a method wherein the first period corresponds to a period within the first 5 minutes such as the period from 0 to 2 minutes of chewing, the second period being after the first period and within the period of from 1 minute to 10 minutes from the beginning of chewing such as from 2 minutes to 5 minutes from the beginning of chewing, a possible third or further period being after the second or third period respectively, and being within the period from 4 to 30 minutes of chewing such as from 5 to 30 minutes from the beginning of chewing, preferably from 5 to 20 minutes of chewing.

It should be noted that the method according to the present invention provides a method for designing a chewing gum formulation which is adapted to a specific active ingredient by establishing whether an increased release in any period is necessary in order not to exceed MAC in any chewing period. By recording the actual period in relation to a period when MAC is increased, a subsequent adaptation of the chewing gum formulation possible. Similarly, it may be established whether a decreased release in any period is necessary in order not to exceed MAC in any chewing period, and recording the actual period and perform the relevant adaptation of the formulation.

The method according to the present invention also encompasses the situation wherein it is established whether an increased release in any period as well as a decreased release in any other period is necessary in order not to exceed MAC during any of the chewing periods. The periods are preferably recorded with respect to the time after the beginning of chewing in order to select a suitable adaptation to the specific situation. However, an adaptation of the formulation may be based solely on the knowledge of the periods in relation to each other.

In case it is established that MAC is not exceeded in any period by use of the desired amount of the active ingredient as illustrated herein as situation a, the amount of the active ingredient may be increased if desired and the method may be used as an procedure for establishing the highest possible amount which may be released within a specific period without an unacceptable taste.

When MAC is not exceeded in a first period but in one or more following periods, the chewing gum formulation may subsequently be adapted to control the release of the active ingredient in the chewing period when the MAC has been exceeded by one or more of the following adaptations of the chewing gum formulation compared to the standard formulation:

i) increase in the amount of solubilizer and/or use of one or more solubilizers having a higher HLB (hydrophilic-lipophilic balance) value

ii) increase in the lipophilic character of the active ingredient or of a part of the active ingredient

iii) increase in the amount of gum base and/or increase in the lipophilic/hydrophilic ratio of the gum base

iv) increase in the hydrophilic character of the active ingredient or of a part of the active ingredient.

Such situations are illustrated herein as situations b, c, and d.

In the situation d illustrated herein where MAC is exceeded in a period followed by a period wherein MAC is not exceeded, the chewing gum formulation may subsequently be adapted to control the release of the active ingredient in the chewing period by increasing the hydrophilic character of the active ingredient or of a part of the active ingredient whereby the concentration of active ingredient is decreased in the former period and increased in one or more of the following periods.

The adaptation of the chewing gum formulation may in one embodiment of d be a combination of

iii) an increase in the amount of gum base and/or increasing the lipophilic/hydrophilic ratio of the gum base; and

iv) an increase in the hydrophilic character of the active ingredient or of a part of the active ingredient in order to increase the release in the first period and decrease the release in the period wherein the MAC was exceeded prior to the adaptation. This situation is illustrated as the long dotted line for curve A in FIG. 14.

A further embodiment of d is where the adaptation of the chewing gum formulation is a combination of

i) increase in the amount of solubilizer and/or use of one or more solubilizers having a higher HLB value, and

iii) increase in the amount of gum base and/or increase in the lipophilic/hydrophilic ratio of the gum base in order to increase the release in the first period and decrease the release in the period wherein the MAC was exceeded prior to the adaptation. This situation is illustrated with the long dotted line marked A in FIG. 14.

A still further embodiment of d is wherein the adaptation of the chewing gum formulation is a combination of

ii) an increase in the lipophilic character of the active ingredient or of a part of the active ingredient and

iii) an increase in the amount of gum base and/or increase in the lipophilic/hydrophilic ratio of the gum base in order to decrease the release in the period wherein the MAC was exceeded prior to the adaptation and to increase the release in a subsequent period. This situation is illustrated with the small dotted line marked B in FIG. 14.

A further embodiment of the method according to the invention relates to the situation where MAC is exceeded in a period followed by a period wherein MAC is not exceeded and wherein the chewing gum formulation is subsequently adapted to control the release of the active ingredient in the chewing period by decreasing the hydrophilic character of the active ingredient or of a part of the active ingredient whereby the concentration of active ingredient is decreased in the former period and increased in one or more of the following periods. Such situations are exemplified as e, f, g and h, in FIGS. 15 to 18, respectively.

When MAC is exceeded in a first period but not in one or more of the following periods, the chewing gum formulation may subsequently be adapted to control the release of the active ingredient in the chewing period when the MAC has been exceeded by one or more of the following adaptations of the chewing gum formulation compared to the standard formulation:

i) increase in the lipophilic character of the active ingredient or of a part of the active ingredient

ii) increase in the amount of gum base and/or increase in the lipophilic/hydrophilic ratio of the gum base. This is illustrated in FIGS. 15 to 18, respectively.

Situation e is a situation where the release is very fast in the beginning of the chewing period, f illustrates a rarer situation with for example relative lipophilic active drugs which are partly present in a coat or in an outer layer of the chewing gum. In g the only possible way of decreasing the concentration to an acceptable level is to increase the release period. A more detailed reference of the situations f, g and h follows.

Situation f is wherein the MAC is exceeded in a first period but not in a second period and MAC is exceeded in a subsequent third period and wherein the chewing gum formulation is subsequently adapted to control the release of the active ingredient in the chewing periods when the MAC has been exceeded by one or more of the following adaptations of the chewing gum formulation compared to the standard formulation:

i) increase in the lipophilic character of the active ingredient or of a part of the active ingredient

ii) increase in the amount of gum base and/or increase in the lipophilic/hydrophilic ratio of the gum base

whereby the release is decreased in the first periods, increased in a second period, decreased in a third period and optionally increased in a period following the third period.

Situation g is wherein the MAC is exceeded in each of the periods recorded and wherein the chewing gum formulation is subsequently adapted to extend the total release period of the active ingredient in order to decrease release in the chewing periods when the MAC has been exceeded by one or more of the following adaptations of the chewing gum formulation compared to the standard formulation:

i) increase in the lipophilic character of the active ingredient or of a part of the active ingredient

ii) increase in the amount of gum base and/or increase in the lipophilic/hydrophilic ratio of the gum base.

Situation h is the situation where the MAC is exceeded during a relative long period in the beginning of the chewing period. The adaptation may be either of the two possibilities mentioned above or more preferred a combination as a prolonging of the release into the later phase may result in an undesired increase just before the period when the increase was intended. In other words, the high concentration is moved to the second phase which beforehand suffered from a high concentration of active drug in stead of to the third phase.

The present invention furthermore relates to a method for the preparation of a chewing gum comprising an effective amount of an active ingredient and having a substantially constant release of the active ingredient in all chewing phases or periods and wherein the MAC is not exceeded in any of the chewing periods or phases. The method comprises subjecting an active ingredient in a formulation to the method described herein by adapting the formulation until the release has the desired configuration.

By use of the method of the present invention it is possible to prepare a chewing gum comprising an effective amount of an active ingredient and having a relative fast release of the active ingredient in the first chewing phase or period and wherein the MAC is not exceeded in any of the chewing periods or phases.

The standard chewing gum formulation comprises

i) gum base 15-99% w/w

ii) active ingredient 0.001-75% w/w

iii) optionally up to 5% w/w flavour

iv) optionally one or mere high potent sweeteners 0.01-5% w/w

v) optionally one or more solubilizers

vi) bulk sweetener q.s ad 100% w/w

In the preferred embodiment, the standard formulation is selected as the formulation which is the one preferred by the manufacturer in order to end up with an adapted formulation as close as possible to the formulation which is preferred for other reasons (economic reasons, equipment, customer compliance, etc.)

The method according to any of the inventions may include a test system which can be any system available in order to establish a reference concentration such as a MAC value. In fact the test system may be a test panel with one or more test persons.

The test system may preferably include a panel of test persons for identifying MAC and which thereby represents the customer acceptable taste of the active ingredient. One such test system or method is described in detail in the example section.

According to the present invention MAC may be defined as a percentage of the average of the acceptable concentration measured in the test system or it may be a value identified by any other means, be a randomly selected value for testing the release property of a standard formulation. MAC may be measured directly or indirectly, e.g. by use of a marker.

The measuring of the release of the active ingredient from the chewing gum formulation during chewing is preferable performed in a chewing machine. Chewing machines are well known in the field of pharmaceuticals and in the chewing gum industry. In addition, the measuring of the release of the active ingredient from a standard chewing gum formulation during chewing may also be performed by one or more test persons. The complete or full chewing period is very rarely relevant for more than 90 minutes due to the lapse of use compliance. Accordingly, the chewing is preferable less than 90 minutes, preferably not exceeding 60 minutes such as no more than 45 minutes from the beginning of chewing.

The preferred method is therefore a method where the total chewing period is measured for 40 minutes from the start of the chewing, preferably for 35 minutes such as for 30 minutes. Where a relative fast release is desired, the complete chewing period is measured for 25 minutes from the start of the chewing, preferably for 20 minutes such as for 15 minutes.

It is further preferred, but not necessary, that the complete chewing period is divided in at least 2 periods such as at least 3 periods. However, 4, 5, up to e.g. 10 periods may be incorporated into the method.

The increase in the amount of solubilizers in order to obtain an adaptation resulting in a control of the release, this increase is at least 2% w/w such as at least 5% w/w compared with the amount of the standard formulation. Similarly, the increase in the amount of gum base is at least 2% w/w such as about at least 5% w/w.

It should be noted that in similarity with the fact that an increase in gum base results in a delay in release, a decrease will result in a faster release and this may be an option in any of the situations b, c, and d.

An increase in the lipophilic character of the active ingredient or of a part of the active ingredient is by use of a lipophil coating of the ingredient or by any other method known in the art to alter a lipophil/hydrophil balance of a substance. Accordingly, selecting a different salt of the active ingredient is also a solution according to the invention.

The increase in the hydrophilic character of the active ingredient or of a part of the active ingredient may be by encapsulation of the ingredient with a hydrophilic component or in any other manner known in the field.

Encapsulation with a hydrophilic component or any other increase in the hydrophile character of the active ingredient may be for use in combination with an increase in gum base, and especially in the situation where the increase in gum base is performed in order to decrease release in a first period and the encapsulation counteract the resulting increase in the release in a later period.

In many situations it may be desired to include an active ingredient into the coating of a chewing gum as well as into the centre of the chewing gum formulation. Such formulations are also within the scope of the invention and the final coated chewing gum may be subject to the method disclosed herein. In order to “move” a release to the first phase or period of chewing, incorporation of a part of the active ingredient may be an appropriate approach.

One important factor with respect to the standard formulation may be to select a sufficient sweetness of the standard formulation in order to have as much bad taste masked by this traditional way. The test system may include a formulation having a similar sweetness for optimising the system.

The products and use according to the invention include use of a pharmaceutically active ingredient together with at least one flavour. The flavour may then be released simultaneously with the pharmaceutical and thereby contribute to an taste masking effect.

The product according to the invention may preferably be a candy, chewing gum, or an oral pharmaceutical composition. In the latter case, the active ingredient is a pharmaceutically active ingredient including ingredients for local treatment on the oral cavity or oral hygienic ingredients. The active ingredients are described in further detail below.

The invention also relates to a chewing gum formulation having controlled release of an active ingredient and comprising, a) an insoluble gum base; b) a water soluble portion; c) a flavour

The aroma agents and flavours usable for the compositions according to the present invention are for instance natural and synthetic flavourings (including natural flavourings) in the form of freeze-dried natural vegetable components, essential oils, essences, extracts, powders, including acids and other substances capable of affecting the taste profile. Examples of liquid and powdered flavourings include coconut, coffee, chocolate, vanilla, grape fruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above.

In a preferred embodiment, the flavour is one or more natural flavouring agent which is freeze-dried, preferably in the form of a powder, slices or pieces of combinations thereof. The particle size may be less than 3 mm, such as less than 2 mm, more preferred less than 1 mm, calculated as the longest dimension of the particle. The natural flavouring agent may in a form where the particle size is from about 3 μm to 2 mm, such as from 4 μm to 1 mm. The preferred natural flavouring agent comprises seeds from a fruit e.g. from strawberry, blackberry and raspberry, and which seeds are substantially intact.

Various synthetic flavours, such as mixed fruit may also be used according to the present invention. As indicated above, the aroma agent may be used in quantities smaller than those conventionally used. The aroma agents and/or flavours may be used in an amount of from 0.01 to about 30 weight-% of the final product depending on the intensity of the aroma and/or flavour used. Preferably, the content of aroma/flavour is in the range from 0.2 to 3% of the total composition.

The invention is suitable for increased or accelerated release of active agents selected among the group dietary supplements, oral and dental compositions, antiseptic agents, pH adjusting agents, anti-smoking agents, sweeteners, flavourings, aroma agents or drugs.

The active agents to be used in connection with the present invention may be any substance desired to be released from the chewing gum. The active agents, for which a controlled and/or accelerated rate of release is desired, are primarily substances with a limited water-solubility, typically below 10 g/100 ml inclusive of substances which are totally water-insoluble. Examples are medicines, dietary supplements, oral compositions, anti-smoking agents, highly potent sweeteners, pH adjusting agents, flavourings etc.

Other active ingredients are, for instance, paracetamol, benzocaine, cinnarizine, menthol, carvone, coffeine, chlorhexidine-di-acetate, cyclizine hydrochloride, 1,8-cineol, nandrolone, miconazole, mystatine, aspartame, sodium fluoride, nicotine, saccharin, cetylpyridinium chloride, other quaternary ammoniumcompounds, vitamin E, vitamin A, vitamin D, glibenclamide or derivatives thereof, progesterone, acetylsalicylic acid, dimenhydrinate, cyclizine, metronidazole, sodium hydrogencarbonate, the active components from ginkgo, the active components from propolis, the active components from ginseng, methadone, oil of peppermint, salicylamide, hydrocortisone or astemizole.

Examples of active agents in the form of dietary supplements are for instance salts and compounds having the nutritive effect of vitamin B2 (riboflavin), B12, folinic acid, niacine, biotine, poorly soluble glycerophosphates, amino acids, the vitamins A, D, E and K, minerals in the form of salts, complexes and compounds containing calcium, phosphorus, magnesium, iron, zinc, copper, iodine, manganese, chromium, selenium, molybdenum, potassium, sodium or cobalt.

Furthermore, reference is made to lists of nutrients accepted by the authorities in different countries such as for instance US code of Federal Regulations, Title 21, Section 182.5013.182 5997 and 182.8013-182.8997.

Examples of active agents in the form of compounds for the care or treatment of the oral cavity and the teeth, are for instance bound hydrogen peroxide and compounds capable of releasing urea during chewing.

Examples of active agents in the form of antiseptics are for instance salts and compounds of guanidine and biguanidine (for instance chlorhexidine diacetate) and the following types of substances with limited water-solubility: quaternary ammonium compounds (for instance ceramine, chloroxylenol, crystal violet, chloramine), aldehydes (for instance paraformaldehyde), compounds of dequaline, polynoxyline, phenols (for instance thymol, para chlorophenol, cresol) hexachlorophene, salicylic anilide compounds, triclosan, halogenes (iodine, iodophores, chloroamine, dichlorocyanuric acid salts), alcohols (3,4 dichlorobenzyl alcohol, benzyl alcohol, phenoxyethanol, phenylethanol), cf. furthermore Martindale, The Extra Pharmacopoeia, 28th edition, page 547-578; metal salts, complexes and compounds with limited water-solubility, such as aluminium salts, (for instance aluminium potassium sulfate AlK(SO₄)₂, 12H₂O) and furthermore salts, complexes and compounds of boron, barium, strontium, iron, calcium, zinc, (zinc acetate, zinc chloride, zinc gluconate), copper (copper chloride, copper sulfate), lead, silver, magnesium, sodium, potassium, lithium, molybdenum, vanadium should be included; other compositions for the care of mouth and teeth: for instance; salts, complexes and compounds containing fluorine (such as sodium fluoride, sodiummonofluorophosphate, aminofluorides, stannous fluoride), phosphates, carbonates and selenium.

Cf. furthermore J. Dent.Res. Vol. 28 No. 2, page 160-171, 1949, wherein a wide range of tested compounds is mentioned.

Examples of active agents in the form of agents adjusting the pH in the oral cavity include for instance: acceptable acids, such as adipinic acid, succinic acid, fumaric acid, or salts thereof or salts of citric acid, tartaric acid, malic acid, acetic acid, lactic acid, phosphoric acid and glutaric acid and acceptable bases, such as carbonates, hydrogen carbonates, phosphates, sulfates or oxides of sodium, potassium, ammonium, magnesium or calcium, especially magnesium and calcium.

Examples of active agents in the form of anti-smoking agents include for instance: nicotine, tobacco powder or silver salts, for instance silver acetate, silver carbonate and silver nitrate.

In a further embodiment, the sucrose fatty acid esters may also be utilised for increased release of sweeteners including for instance the so-called highly potent sweeteners, such as for instance saccharin, cyclamate, aspartame, thaumatin, dihydrocalcones, stevioside, glycyrrhizin or salts or compounds thereof. For increased released of sweetener, the sucrose fatty adds preferable have a content of palmitate of at least 40% such as at least 50%.

Further examples of active agents are medicines of any suitable type.

Examples of active agents in the form of medicines include caffeine, salicylic add, salicyl amide and related substances (acetylsalicylic acid, choline salicylate, magnesium salicylate, sodium salicylate), paracetamol, salts of pentazocine (pentazocine hydrochloride and pentazocinelactate), buprenorphine hydrochloride, codeine hydrochloride and codeine phosphate, morphine and morphine salts (hydrochloride, sulfate, tartrate), methadone hydrochloride, ketobemidone and salts of ketobemidone (hydrochloride), beta-blockers, (propranolol), calcium antagonists, verapamil hydrochloride, nifedinpine as well as suitable substances and salts thereof mentioned in Pharm. Int., Nov.85, pages 267-271, Barney H. Hunter and Robert L Talbert, nitroglycerine, erythrityl tetranitrate, strychnine and salts thereof, lidocaine, tetracaine hydrochloride, etorphine hydrochloride, atropine, insulin, enzymes (for instance papain, trypsin, amyloglucosidase, glucoseoxidase, streptokinase, streptodomase, dextranase, alpha amylase), polypeptides (oxytocin, gonadorelin, (LH.RH), desmopressin acetate (DDAVP), isoxsuprine hydrochloride, ergotamine compounds, chloroquine (phosphate, sulfate), isosorbide, demoxytocin, heparin.

Other active ingredients include beta-lupeol, Letigen®, Sildenafil citrate and derivatives thereof.

Dental products include Carbami, CPP Caseine Phospho Peptide; Chlorhexidine, Chlorhexidine di acetate, Chlorhexidine Chloride, Chlorhexidine di gluconate, Hexetedine, Strontium chloride, Potassium Chloride, Sodium bicarbonate, Sodium carbonate, Fluor containing ingredients, Fluorides, Sodium fluoride, Aluminium fluoride Ammonium fluoride, Calcium fluoride, Stannous fluoride, Other fluor containing ingredients Ammonium fluorosilicate, Potassium fluorosilicate, Sodium fluorosilicate, Ammonium monofluorphosphate, Calcium monofluorphosphate, Potassium monofluorphosphate, Sodium monofluorphosphate, Octadecentyl Ammonium fluoride, Stearyl Trihydroxyethyl Propylenediamine Dihydrofluoride,

Vitamins include A, B1, B2, B6, B12, Folin acid, niacin, Pantothensyre, biotine, C, D, E, K. Minerals include calcium, phosphor, magnesium, iron, zinc, copper, iodine, manganese, chromium, selenium, molybdenum. Other active ingredients include: Q10®, enzymes. Natural drugs including Ginkgo Biloba, ginger, and fish oil. The invention also relates to use of migraine drugs such as Serotonin antagonists: Sumatriptan, Zolmitriptan, Naratriptan, Rizatriptan, Eletriptan; nausea drugs such as Cydizin, Cinnarizin, Dimenhydramin, Difenhydrinal; hay fever drugs such as Cetrizin, Loratidin, pain relief drugs such as Buprenorfin, Tramadol, oral disease drugs such as Miconazol, Amphotericin B, Triamcinolonaceton; and the drugs Cisaprid, Domperidon, Metoclopramid. In a preferred embodiment the invention relates to the release of Nicotine and its salts

A further particularly preferred preparation according to the invention comprises up to 50 weight-%, preferably 0.1-10 weight-% active agent in the form of a solid dispersion hereof in a carrier, up to 60 weight-%, preferably approximately 20 weight-% of the carrier used to obtain the solid dispersion, 0.1-30 weight-%, preferably 0.1-10 weight-% solubilizer, 15-80 weight-%, preferably approximately 35 weight-% chewing gum base and up to 85 weight-%, preferably approximately 35 weight-% auxiliary substances and additives.

A particularly preferred preparation according to the invention comprises up to 50 weight %, preferably 0.1-10 weight-% active agent admixed with at least one solubilzer, 15-80 weight-%, preferably approximately 35 weight-% chewing gum base, up to 85 weight-%, preferably approximately 50-60 weight-% auxiliary agents and additives and 0.1-30 weight-%, preferably approximately 5 weight-% solubilizer.

The invention further relates to a process for the preparation of a chewing gum composition, which process is characterised by preparing a chewing gum base on the basis of conventional chewing gum base constituents, wherein the resin portion consists of at least 25 weight-% of a resin selected among terpene resins, glycerol ester of polymerised rosin, pentaerythritol ester of polymerised rosin, pentaerythritol ester of wood or gum rosin, pentaerythritol ester of partially hydrogenated wood or gum rosin, glycerol ester of partially hydrogenated wood or gum rosin and high molecular weight polyvinyl acetate resins with a molecular weight of at least 30,000, and then in a conventional manner preparing a chewing gum composition while adding active agent, solubilizer and other conventional ingredients.

A particular embodiment according to the invention is characterised in that the active agent is closely mixed with the solubilizer, optionally during heating, before adding to the chewing gum composition.

If a carrier is used, the process may advantageously be carried out by forming a solid dispersion of the active agent in a carrier prior to mixing the active agent with the solubilizer.

It is clear that the improved properties with respect to release obtained according to the present invention are of great importance when used with the active ingredients mentioned above. The active ingredients may be used in higher dosages, otherwise resulting in disadvantages according to side effects relating to the taste of the active ingredient.

According to the present invention a preferred gum base comprises a sucrose fatty acid ester in a conventional formulation and includes formulations wherein the chewing gum base contains about 5 weight-% to 50 weight-% elastomer which may be of natural or more preferred of synthetic origin, about 5 to about 55 weight-% elastomer plasticizer, about 0 to 50 weight-% filler, about 5 to about 35 weight-% softener, and optional minor amounts (about 1% or less) of miscellaneous ingredient such as antioxidants, colorants, etc.

Sucrose fatty acid ester includes at least 50%, such as at least 60%, preferably at least 70%, more preferred at least 80%, still more preferred at least 90%, most preferred about 100%.

According to the present text, the term softener is used for ingredients, which softens the gum or chewing gum formulation and encompass wax, fat, oil, emulsifiers, surfactants, solubilizers etc.

The gum base used in the chewing gum according to the invention is generally prepared in a conventional manner by heating and mixing the different ingredients such as elastomers, resins, inorganic fillers, waxes, fats, and emulsifiers etc.

The insoluble gum base generally comprises fats and oils, resins, elastomers, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

Synthetic elastomers may include, but are not limited to, polyisobutylene with a gas pressure chromatography (GPC) average molecular weight of about 10,000 to about 1000 000, isobutylene-isoprene copolymer (butyl elastomer), styrene-butadiene copolymers having styrene-butadiene ratios of about 1:3 to about 3:1, polyvinyl acetate (PVA) having a GPC average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred combinations include, but are not limited to polyisobutylene and styrene-butadiene, polyisobutylene and polyisoprene, polyisobutylene and isobutylene-isoprene copolymer (butyl rubber), polyisobutylene, styrene-butadiene copolymer, and isobutylene isoprene copolymer, and all of the above in admixture with polyvinyl acetate, vinyl acetate-vinyl laurate copolymers and admixtures thereof.

Preferred ranges are, for polyisobutylene, 50,000 to 80,000 GPC average molecular weight, for styrene-butadiene, 1:1 to 1:3 bound styrene-butadiene, for polyvinyl acetate, 3,000 to 80,000 GPC average molecular weight where the higher molecular weight polyvinyl acetates typically used in bubble gum base, and for vinyl acetate-vinyl laurate, a vinyl laurate content of 10-45 percent.

Natural elastomers may include natural rubber such as smoked or liquid latex and guayule as well as natural gums such as jelutong, lechi caspi, massaranduba balata, sorva, perillo, rosindinha, massaranduba chocolate, chicle, nispero, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, massaranduba balata and sorva.

Resins should also be mentioned as a component forming part of a chewing gum base, said resins being used to obtain the right chewing consistency and as plasticizer for the elastomers of the chewing gum base.

Elastomers plasticizers may include, but are not limited to, natural rosin esters, often called estergums, such as glycerol esters of partially hydrogenated rosin, glycerol esters polymerised rosin, glycerol esters of partially dimerized rosin, glycerol esters of tall oil rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene, natural terpene resins; and any suitable combinations of the foregoing. The preferred elastomer plasticizers will also vary depending on the specific application, and on the type of elastomer which is used.

The fillers/texturizers that form part of the chewing gum base may include magnesium and calcium carbonate, sodium sulphate, ground limestone, silicate types such as magnesium and aluminium silicate, kaolin, clay, aluminium oxide, silicium oxide, talc, titanium oxide, mono-, di- and tri-calcium phosphates, cellulose polymers, such as wood, and combinations thereof.

The fillers/texturizers may also include natural organic fibres such as fruit vegetable fibres, grain, rice, cellulose and combinations thereof.

In a further embodiment, in addition to the sucrose polyesters, pursuant to the present invention, softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

Waxes may include synthetic waxes such as microcrystalline or paraffin waxes, or natural waxes such as carnauba, beeswax, candellila, or polyethylene wax.

In addition to a water insoluble gum base portion, a typical chewing gum composition includes a water soluble bulk portion and one or more flavouring agents as mentioned above. The water soluble portion can include bulk sweeteners, high intensity sweeteners, flavouring agents, softeners, emulsifiers, colours, acidulants, fillers, antioxidants, and other components that provide desired attributes.

The softeners, which are also known as plasticizers and plasticizing agents, generally constitute between approximately 0.5 to about 30% by weight of the chewing gum. The softeners may, in addition to including sucrose polyesters, include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute 5 to about 95% by weight of the chewing gum, more typically constitute 20 to about 80% by weight, and more commonly, 30 to 60% by weight of the gum.

Sugar sweeteners generally include saccharide-containing components commonly known in the chewing gum art, but not limited to, sucrose, dextrose, maltose, dextrin, trehalose, D-tagatose, dried invert sugar, fructose, levulose, galactose, corn syrup solids, and the like, alone or in combination.

Sorbitol can be used as a sugarless sweetener. Additionally, sugarless sweeteners can include, but are not limited to, other sugar alcohols such as mannitol, xylitol, hydrogenated starch hydrolysates, maltitol, isomalt, erythritol, lactitol and the like, alone or in combination.

High intensity artificial sweeteners can also be used in combination with the above. Preferred sweeteners indude, but are not limited to sucralose, aspartame, salts of acesulfame, alitame, saccharin and its salts, cyclamic acid and its salts, glycyrrhizin, dihydrochalcones, thaumatin, monellin, sterioside and the like, alone or in combination. In order to provide longer lasting sweetness and flavour perception, it may be desirable to encapsulate or otherwise control the release of at least a portion of the artificial sweetener. Such techniques as wet granulation, wax granulation, spray drying, spray chilling, fluid bed coating, coascervation, encapsulation in yeast cells and fibre extrusion may be used to achieve the desired release characteristics. The encapsulation can also be performed in another material such as resin.

Usage level of the artificial sweetener will vary greatly and will depend on such factors as potency of the sweetener, rate of release, desired sweetness of the product, level and type of flavour used and cost considerations. Thus, the active level of artificial sweetener may vary from 0.02 to about 8%. When carriers used for encapsulation are included, the usage level of the encapsulated sweetener will be proportionately higher. Combinations of sugar and/or sugarless sweeteners may be used in chewing gum. Additionally, the softener may also provide additional sweetness such as with aqueous sugar or alditol solutions. If a low calorie gum is desired, a low caloric bulking agent can be used. Examples of low caloric bulking agents include polydextrose; Raftilose, Raftilin; Fructooligosaccharides (NutraFlora®); Palatinose oligosaccharide; Guar Gum Hydrolysate (Sun Fiber®; or indigestible dextrin (Fibersol). However, other low calorie-bulking agent can be used.

Any of the usual elastomers can be used in a quantity of typically 5-50 weight-%. The elastomer may be of natural origin, for instance such as stated in Food and Drug Administration, CFR, Title 21, Section 172,615, as “Masticatory Substances of Natural Vegetable Origin”, or synthetic elastomers, such as styrene butadiene gum (SBR), butyl gum (isobutylene isoprene copolymer), or polyisobutylene (as stated in the above section of FDA under Masticatory Substances, Synthetic).

Waxes and fats are conventionally used for the adjustment of the consistency and softening of the chewing gum base when preparing chewing gum bases. In connection with the present invention any conventionally used and suitable type of wax and fat may be used, such as for instance rice bran wax, polyethylene wax, petroleum wax (refined paraffin and micro crystalline wax), paraffin, beeswax, carnauba wax, candelilla wax, cocoa butter, degreased cocoa powder and any suitable oil or fat, as for instance completely or partially hydrogenated vegetable oils or completely or partially hydrogenated animal fats. In a preferred embodiment, the chewing gum is wax free. The wax of the general formulations may be replaced with hydrogenated oil or fat.

To soften the gum base further and to provide it with water binding properties, which gives the gum bases a pleasant smooth surface and reduces its adhesive properties, one or more emulsifiers may usually be added. Mono and diglycerides of edible fatty acids, lactic acid esters and acetic acid esters of mono and diglycerides of edible fatty acids, acetylated mono and diglycerides, sugar esters of edible fatty acids, Na—, K—, Mg— and Ca-stearates, lecithin, hydroxylated lecithin and the like may be mentioned as examples of legal and conventionally used emulsifiers added to the chewing gum base. In case of the presence of an active ingredient, the formulation may comprise certain specific emulsifiers and/or solubilizers in order to disperse and release the active ingredient.

In addition to the sucrose fatty acid ester, emulsifiers, which are conventionally used in quantities of 0-18 weight-%, preferably 0-12 weight-% of the gum base, may be present.

Furthermore, the chewing gum base may optionally contain the usual additives, such as antioxidants, for instance butylated hydroxytoluene (BHT), butyl hydroxyanisol (BHA), propylgallate and tocopherols as well as preservatives and colorants.

The chewing gum may also comprise the following surfactants and/or solubilizers, especially when active ingredients are present. As examples of types of surfactants to be used as solubilizers in a chewing gum composition according to the invention reference is made to H. P. Fiedler, Lexikon der Hilfstoffe für Pharmacie, Kosmetik und Angrenzende Gebiete, page 63-64 (1981) and the lists of approved food emulsifiers of the individual countries.

Both anionic, cationic, amphoteric, and nonionic solubilizers can be used, but usually the solubilizer used is either anionic or nonionic as mainly such solubilizers are approved for use in food or medicines. In cases where the active agent is reactive it is usually an advantage to use a nonionic solubilizer as it is not very reactive and therefore does not affect the stability of the active agent unfavourably.

Suitable solubilizers include lecithines, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol sters of fatty acids, polyglycerol esters of interesterified castor oil acid (E476), sodium stearoyllatylate, sodium lauryl sulfate and sorbitan esters of fatty acids, which solubilizers are all known for use as food emulsifiers, and polyoxyethylated hydrogenated castor oil (for instance such sold under the trade name CREMOPHOR), blockcopolymers of ethylene oxide and propylene oxide (for instance as sold under the trade name PLURONIC or the trade name POLOXAMER), polyoxyethylene fatty alcohol ethers, polyoxyethylene sorbitan fatty acid esters, sorbitan esters of fatty acids and polyoxyethylene steraric acid ester, all known in the EEC for use as pharmaceutical-cosmetical emulsifiers.

Particularly suitable solubilizers are polyoxyethylene stearates, such as for instance polyoxyethylene(8)stearate and polyoxyethylene(40)stearate, the polyoxyethylene sorbitan fatty acid esters sold under the trade name TWEEN, for instance TWEEN 20 (monolaurate), TWEEN 80 (monooleate), TWEEN 40 (monopalmitate), TWEEN 60 (monostearate) or TWEEN 65 (tristearate), mono and diacetyl tartaric acid esters of mono and diglycerides of edible fatty acids, citric acid esters of mono and diglycerides of edible fatty acids, sodium stearoyllatylate, sodium laurylsulfate, polyoxyethylated hydrogenated castor oil, blockcopolymers of ethylene oxide and propyleneoxide and polyoxyethylene fatty alcohol ether. The solubilizer may either be a single compound or a combination of several compounds. The expression “solubilizer” is used in the present text to describe both possibilities, the solubilizer used must be suitable for use in food and/or medicine.

In the presence of an active ingredient the chewing gum may preferably also comprise a carrier known in the art.

Examples of active agents in the form of antiseptics are for instance salts and compounds of guanidine and biguanidine (for instance chlorhexidine diacetate) and the following types of substances with limited water-solubility: quaternary ammonium compounds (for instance ceramine, chloroxylenol, crystal violet, chloramine), aldehydes (for instance paraformaldehyde), compounds of dequaline, polynoxyline, phenols (for instance thymol, para chlorophenol, cresol) hexachlorophene, salicylic anilide compounds, triclosan, halogenes (iodine, iodophores, chloroamine, dichlorocyanuric acid salts), alcohols (3,4 dichlorobenzyl alcohol, benzyl alcohol, phenoxyethanol, phenylethanol), cf. furthermore Martindale, The Extra Pharmacopoeia, 28th edition, page 547-578; metal salts, complexes and compounds with limited water-solubility, such as aluminium salts, (for instance aluminium potassium sulphate AlK(SO₄)₂, 12H₂O) and furthermore salts, complexes and compounds of boron, barium, strontium, iron, calcium, zinc, (zinc acetate, zinc chloride, zinc gluconate), copper (copper chloride, copper sulphate), lead, silver, magnesium, sodium, potassium, lithium, molybdenum, vanadium should be included; other compositions for the care of mouth and teeth: for instance; salts, complexes and compounds containing fluorine (such as sodium fluoride, sodiummonofluorophosphate, aminofluorides, stannous fluoride), phosphates, carbonates and selenium.

Confer furthermore J. Dent.Res. Vol. 28 No. 2, page 160-171, 1949, wherein a wide range of tested compounds are mentioned.

Examples of active agents in the form of agents adjusting the pH in the oral cavity include for instance: acceptable acids, such as adipinic acid, succinic acid, fumaric acid, or salts thereof or salts of citric acid, tartaric acid, malic acid, acetic acid, lactic add, phosphoric acid and glutaric acid and acceptable bases, such as carbonates, hydrogen carbonates, phosphates, sulphates or oxides of sodium, potassium, ammonium, magnesium or calcium, especially magnesium and calcium.

In one embodiment, where the preparation according to the invention comprises an active ingredient, up to 50 weight-%, preferably 0.1-10 weight-% active agent may be in the form of a solid dispersion hereof in a carrier, up to 60 weight-%, preferably approximately 20 weight-% of the carrier used to obtain the solid dispersion, 0.1-30 weight-%, preferably 0.1-10 weight-% solubilizer, 15-80 weight-%, preferably approximately 35 weight-% chewing gum base and up to 85 weight-%, preferably approximately 35 weight-% auxiliary substances and additives.

The invention further relates to a process for the preparation of a chewing gum composition, which process is characterised by preparing a chewing gum base on the basis of conventional chewing gum base constituents.

The formulation of the chewing gum base depends on the type of chewing gum desired as described above or the required type of structure. Suitable raw materials for the gum base comprise substances according to U.S. Chewing Gum Base Regulations—Code of Federal Regulations, Title 21, Section 172.615.

It is a particular advantage of the invention that the chewing gum composition can be prepared using conventional ingredients, conventional equipment and conventional methods of preparation.

When the active agent has been incorporated in the chewing gum carrier, this product may be of any known type, such as bits, optionally provided with a dragée, and sticks or chewing gum of any other desired form. The chewing gum pieces may be coated with a type of wax, a film coating or a conventional so-called candy coat based on sugar-containing or sugar free substances.

A single piece of chewing gum usually weighs between 0.4 and 20.0 g. The following Table indicates the preferred intervals for the different product types:

| | |
|---|---|
| Chewing gum bits | 500-3,500 mg |
| Coated chewing gum | 600-6,000 mg |
| Chewing gum sticks | 1,000-5,000 mg |

When the individual ingredients forming part of a chewing gum composition according to the invention are mentioned in singular, such mention also comprises a combination of several such ingredients, apart from instances where one particular ingredient is mentioned.

In a further embodiment, bubble gum formulation may also be prepared with the sucrose fatty acids according to the invention.

The invention is illustrated in more details below by means of the Examples, which are not limiting for the present invention.

Examples of chewing gum bases:

Preparation of a chewing gum base suitable for an ordinary chewing gum.

| | |
|---|---|
| Synthetic elastomer | 15% |
| Polyvinyl acetate (PVA) | 22% |
| Elastomer plasticizer | 26% |
| Filler | 14% |
| Softeners | 23% |

Preparation of a chewing gum base suitable for a chewing gum comprising an active ingredient.

| | |
|---|---|
| Elastomers | 4 weight-% |
| Terpene resin | 28 weight-% |
| PVA | 29 weight-% |
| Emulsifier | 6 weight-% |
| Sucrose fatty acid ester | 2 weight-% |
| Waxes | 31 weight-% |

The elastomer is masticated in a conventional mixer for the preparation of chewing gum and gum base while being heated to 110-130° C. and terpene resin and low molecular weight PVA are added slowly in small portions. Finally waxes and emulsifier are added. To ensure a homogenous base it is important that all the ingredients are added in small portions and that the subsequent portions are not added until the preceding portion is mixed

Preparation of Chewing Gum

Examples of a chewing gum prepared according to the present invention:

Basic Formulation 1, comprising an active ingredient.

| | |
|---|---|
| Gum base | 35 weight-% |
| Sorbitol powder | 10 weight-% |
| Hydrogenated glucose syrup | 10 weight-% |
| Active agent | 0.01-30 weight-% |
| Solubilizer | 0-20 weight-% |
| Optional flavour | 1.9 weight-% |
| Optional additional sorbitol powder q.s. | 100 weight-% |

The chewing gum pieces are prepared in the conventional manner for the preparation of chewing gum and using a conventional apparatus for the preparation of chewing gum.

The chewing gum base is softened in a conventional chewing gum mixer. The other ingredients are admixed one by one, preferably in the order mentioned. A possible active agent may be admixed separately or in the form of a pre-mixture or in a solution. Depending on the state of the ingredients and their melting points, such pre-mixture may be a simple mixture of two or more powders, a mixture of one or more powders in one or more liquids or a mixture of more liquids at ordinary, increased or lower temperature. To ensure a good dispersion of the ingredients it may, especially when adding very small quantities of one or more of the components of the pre-mixture, be an advantage to add these as a liquid mixture or a solution where this is possible.

Apart from mixing the gum base first, the order of the admixture is not critical. However, the mixing should be of a duration which is long enough to ensure a sufficiently good dispersion of the ingredients in the chewing gum mass. Optionally supplementary flavourings are usually added lastly followed by mixing for 2 to 3 minutes.

Upon completion of the mixing, the homogenous chewing gum mass is removed from the mixer and cut out and left to cool in small pieces or is extruded to a thin sheet, which is led through a cooling apparatus. The thin sheet is rolled on a conventional chewing gum rolling system and cut into bits of appropriate form and size.

The bits are left to harden for two to five days and are then separated by tumbling in a conventional dragée pan. Subsequently, the bits are completed by applying a thin polishing layer of film coating or a dragée coating is provided.

### LEGENDS TO FIGURES

FIG. 1. Chewing gum release

FIG. 2. Release after 10 minutes versus solubility (G/100 ml)

FIG. 3. Release in vivo of chlorhexidine diacetate chewing gum

FIG. 4. Miconazol salivary concentration as a consequence of various solubilizer percentages

FIG. 5. Miconazol salivary concentration as a consequence of different solubilizers

FIG. 6. Release of paracetamol—with and without solubilizer

FIG. 7. Nandrolon release in vitro—with and without cyclodextrin.

FIG. 8. Release of sodiumaluminum-dodecahydrate with and without PVAc

FIG. 9. C-vitamin chewing gum—with 30% gum base and 45% gum base

FIG. 10. Sensory stimulus illustrated versus concentration

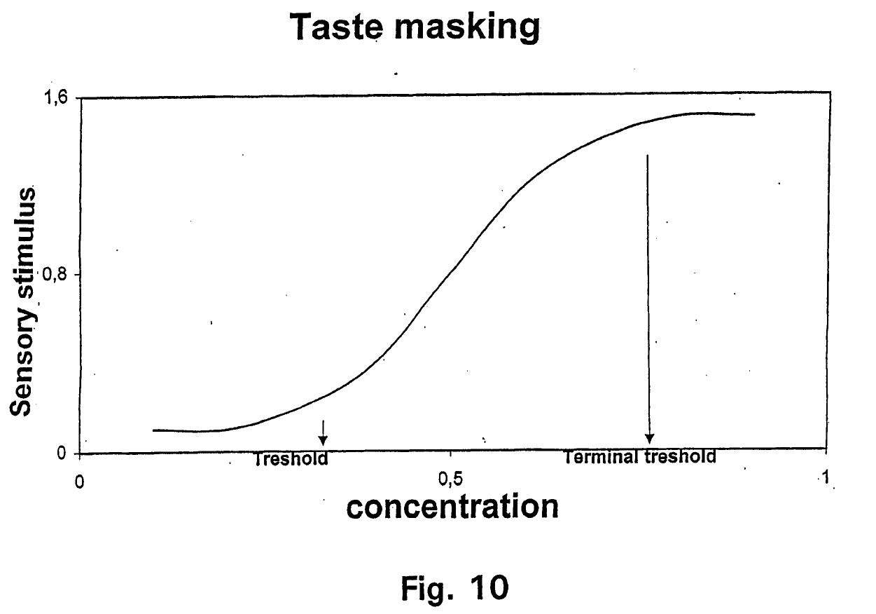

FIG. 11. Situation a in phases I, II and III, and the release a

FIG. 12. Situation b in phases I, II and III, and the release b

FIG. 13. Situation c in phases I, II and III, and the release c

FIG. 14. Situation d in phases I, II and III, and the release d

FIG. 15. Situation e in phases I, II and III, and the release e

FIG. 16. Situation f in phases I, II and III, and the release f

FIG. 17. Situation g in phases I, II and III, and the release g

FIG. 18. Situation h in phases I, II and III, and the release h

List of Relevant Active Ingredients:

Active ingredient

| Therap. group | INN name | Sale name |
|---|---|---|
| Anxiety | Lorazepam | Ativan |
| | Buspiron | Buspar |
| | Alprazolam | Xanax |
| | Fluoxetin | Prozac |
| | Citalopram | Cipramil/Celexa |
| Migraine | Eletriptan | Relpax |
| | Sumatriptan | Imigran |
| | Naratriptan | Naramig |
| | Ergotamine | |
| | Zolmitriptan | Zomig |
| | Frovatriptan | Miguard |
| Allergic | Cetrizine | |
| | Cetrizine dihydrochloride | |
| | Vaccines | |
| | Loratidin | Claritin |
| | Fexofenadin | Telfast/Allegra |
| | Montelukast | Singulair |
| | Zafirlukast | Accolate |
| Expectorant | Acetylsystein | Mucomyst |
| | Bromhexine | |
| | Ambroxol HCl | |
| Motion sickness | Cinnarizine | |
| | Dimenhydrinat | |
| | Difenhydramin | |
| | Cyklizin-nej | |
| | meclozin | |
| | promethazin | |
| | Scopolamin | |
| | Ondansetron | Zofran |
| | Granisetron | Kytril |
| Parodontosis | Chlorhexidine di | |
| | acetate | |
| | Chlorhexidine di | |
| | chloride | |
| | Chlorhexidine di | |
| | gluconate | |
| | Cetylpyridinium | |
| | Chloride | |
| | Benzalconium | |
| | Chloride | |
| | Hexitidine | |
| | Triclosan | |
| | Benzethonium | |
| | Chloride | |
| | lod-forbindelser | |
| Diabetes type II | Rosiglitazone | Avandia |
| | Nateglinide | Starlix |
| | G1262570 | (Glaxo) |
| | Glibenclamide | |
| | Repoglimide | NovoNorm |
| | Troglitazone | Nascal |
| Pain | Acetylsalicylsyre | Aspirin |
| | Ibuprofen | Ibuprofen |
| | Paracetamol | |
| | Naproxen | Naprosyn |
| | Codeine | |
| | hydrochloride | |
| | Morfine | |
| | Fentanyl | Duragesic |
| | Tramadole | Ultram |
| | Celecoxid | Celebrex |
| | Rofecoxid | Vioxx |
| | Diclofenac | Voltaren |
| Osteoporosis | calcium compounds | |
| | Raloxifen | Evista |
| | Alendronate | Fosamax |
| Adipositas | Orlistat | Xenical |
| | (Nicotine + caffeine) | |
| | Ephedrine + caffeine | |
| | PPA (Phenyl Propanol Amine) | |
| Erectil dysfunktion | Siledenafil | Viagra |
| | Vardenafil | |
| | Apomorfin | |
| Anti fungal | Miconazole | |
| Anti smoke | Nicotine | |
| | Cotinine | |
| | lobeline | |
| | Bupropion | Zyban |
| Antacida | | |
| Anorexica | | |
| Angina Pectoris | Nitroglycerin | |
| Influenza | Amantidin | |
| (profylactive) | | |
| | Rimantadin | |
| Hormon | Melatonin | |
| | Leuprolide | |
| Natural medicaments | Perikum = St. Johns Wort | |
| | Ginkgo Biloba | |
| | Ginseng | |
| Ulcus | Disulfiram | |
| | Cimetidine | |
| | Famotidine | |
| Vitamin/Mineral | | |
| Diverse ingredients | | |
| | Nifedipin | |
| | Dextrometorfane | Dextrofan |
| | Chlorpheniramine | |
| | Metronidazole | |
| | Benzocaine | |
| | Lidocaine | |
| | Sodium fluoride | |
| | Sodium mono fluorphosphate | |
| | Fluro compounds | |
| | Propolis | |

### EXAMPLE 1

Summary of Release Principles

1. Release Principles

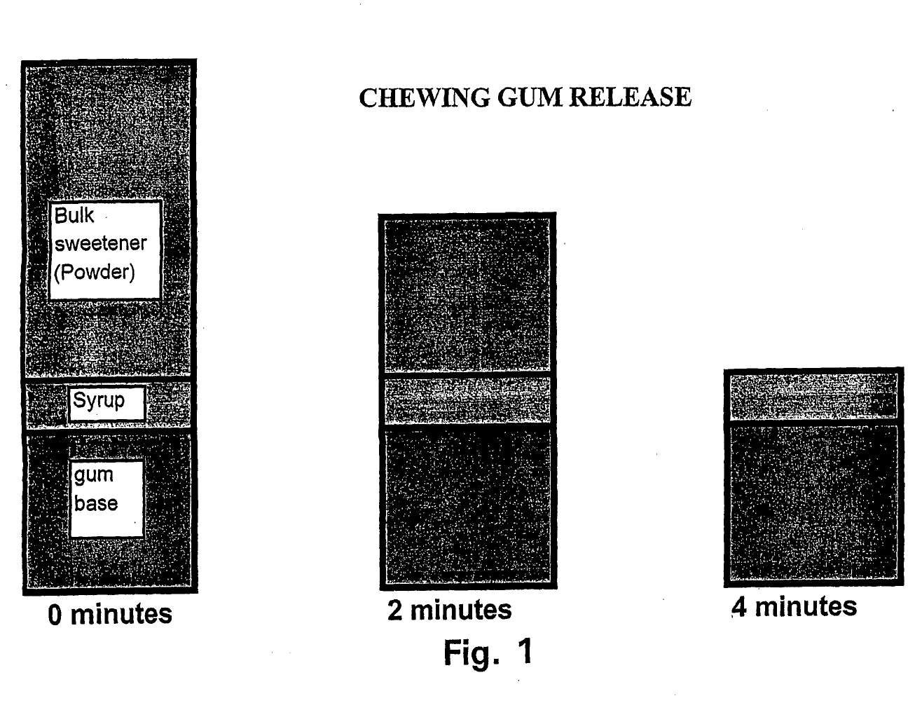

In principle, chewing gum constists of 3 phases (FIG. 1)

| | |
|---|---|
| a water-soluble hydrophilic phase | (50-80%) |
| a non water-soluble hydrophobic phase | (15-40%) |
| a fluid phase | (0-15%) |

These parts are normally profoundly mixed in the chewing gum.

During the chewing process the hydrophilic part disappears, usually during the first 2-5 minutes, whereas the hydrophobic part remains with approx. 2040% water/salivary, which have been emulsified into the gum mass (FIG. 1).

Thus, water-soluble substances are easily released from the chewing gum, whereas the non water-soluble substances are more or less tied up to the gum base.

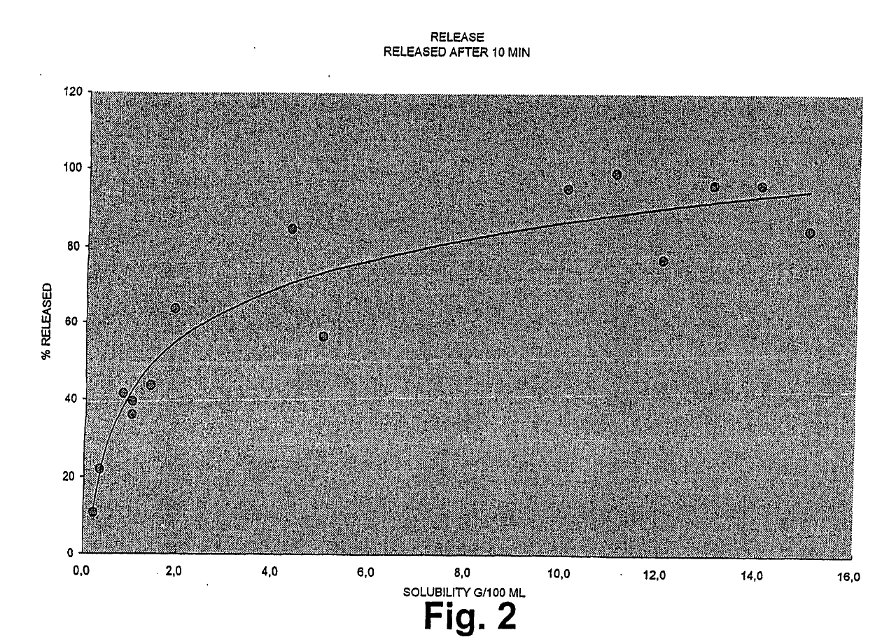

Substances with a water-solubility of over 10 g/100 ml are often completely released during 10-15 minutes of chewing, whereas substances with a solubility under 1 g/100 ml can normally not be released within an acceptable duration of chewing (FIG. 2).

Since most active medical substances are lipophilic, the release purpose is to make such heavily soluble substances releasable, but also other release problems could be of relevance, i.e. delaying the emission or delivery of a slightly soluble substance to a local treatment in the mouth.

2. Change of Release

The methods to change the release profile determined by the soluble conditions can be divided into 3 categories:

2.1 Influence of the Active Ingredient Properties

2.2 Change of the Chewing Gum Formulation

2.3 Process-Oriented Methods

2.1 The Influence of the Active Ingredient Properties

By changing the lipophilic/hydrophilic properties of the active ingredient the following effect on the release velocity can be expected:

| | |
|---|---|
| Active substance | “Properties of treatment means” |

| properties | Hydrophilic | Hydrophobic |
|---|---|---|
| Hydrophilic | Faster | More slowly |
| Hydrophobic | Faster | More slowly |

In a medical connection it is primarily the underlined situations which are of interest.

The methods which can be used to combine the soluble properties of the active ingredient and thus its release, are numerous.

Below, the preferred methods and formulation principles are dealt with.

A. Active Substance Form

Often, a given medical substance is in the form of different salts or chemical modifications; and also in these connections it is possible to reach a satisfactory release process from the chewing gum, only by choosing the most suitable combination seen from a releasing point of view.

Other considerations such as taste of the substance or bio-availability can necessitate a less optimal choice considering release.

Chlorhexidine serves as an example of the choice as to the best releasable chemical combination.

Chlorhexidine occurs as the following ordinary, commercially available salts:

| | | |
|---|---|---|
| Chlorhexidine digluconat: | water-soluble: | mixable |
| Chlorhexidine diacetate: | water-soluble: | 1.9 g/100 ml |
| Chlorhexidine dihydrochloride | water-soluble: | 0.06 g/100 ml |

All 3 combinations have a sharp, bitter taste.

Tests with a digluconate compound resulted in a product with a very fast release and thus a fully unacceptable taste in the beginning of the chewing process.

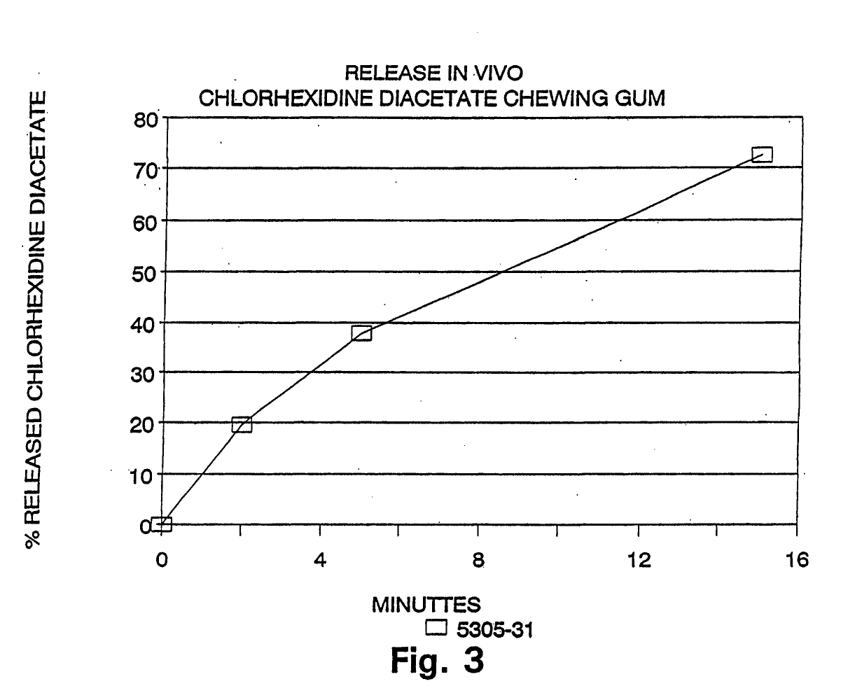

With the diacetate compound a steady release over 30 minutes was achieved, and a level of bitterness which was possible to taste mask during the whole chewing process (FIG. 3).

As it appears, there is a good conformity with the expected release velocity based on the curve in FIG. 3.

Chlorhexidine dihydrochloride has not been tested in chewing gum formulations, but with an expected release velocity of under 10% after 10 minutes, certain incentives would be necessary in order to obtain an acceptable release.

B. Solubilizers

A method for increasing the release from the chewing gum of substances with a low solubility, would be very suitable for many medical substances, is the use of surface active ingredients, solubilizers in the chewing gum.

In smaller quantities, surface active ingredients are already used for chewing gum in which it is particularly used for regulating the texture of the piece.

The addition of a larger quantity of particularly surface active ingredients, which have a great effect on the release velocity, will result in a far too heavy softening of the gum base, as it becomes sticky and possibly disintegrates.

In order to avoid this, it is necessary to have a specially mixed gum base.

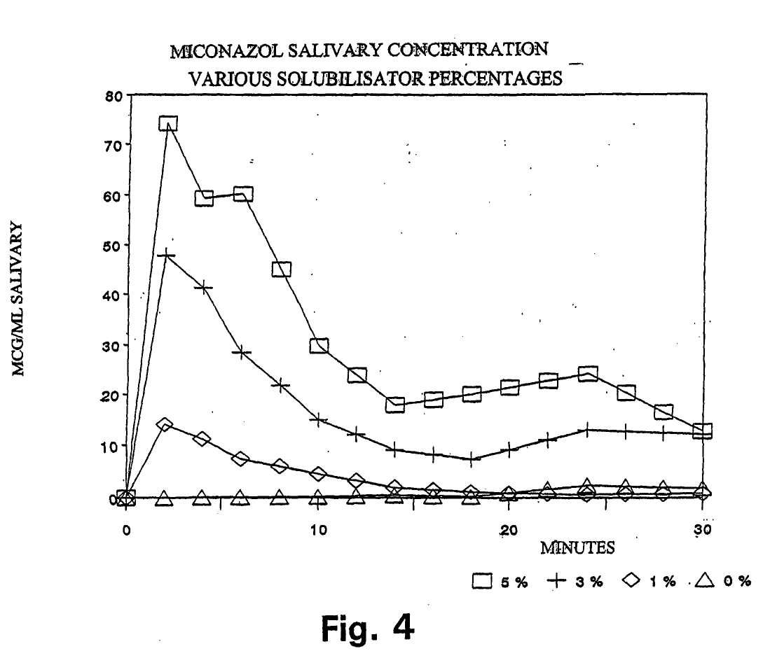

As an example of a substance with a very low water-solubility led to release in a chewing gum formulation by adding a solubilizer. FIG. 4 shows the in vitro release results of the “salivary concentration” from a number of tests with different concentrations of a solubilizer in a chewing gum formulation with 50 mg Miconazol (Solubility in water <0.001 g/100 ml).

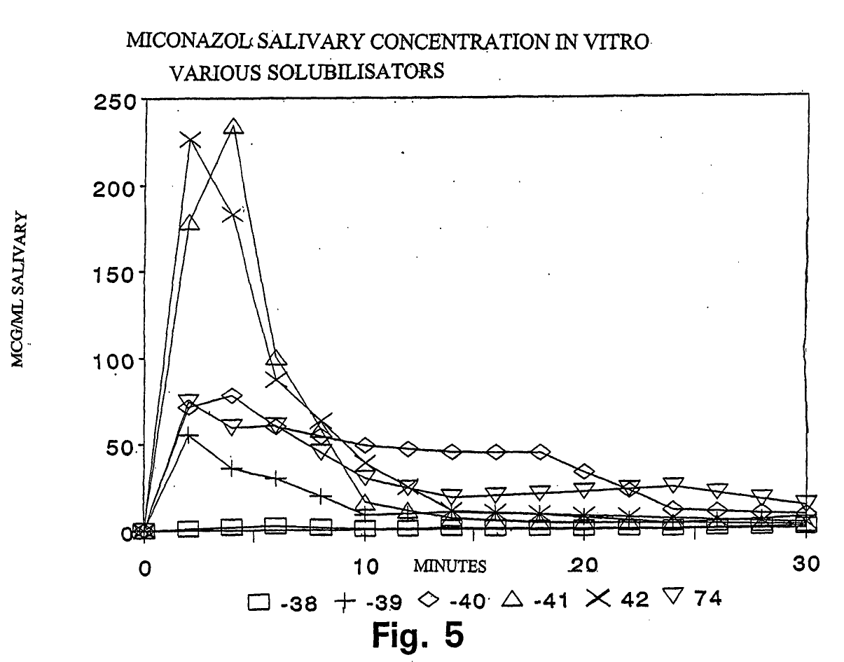

In FIG. 5, the effect of different types of solubilizers of the same meconazol formulation is shown.

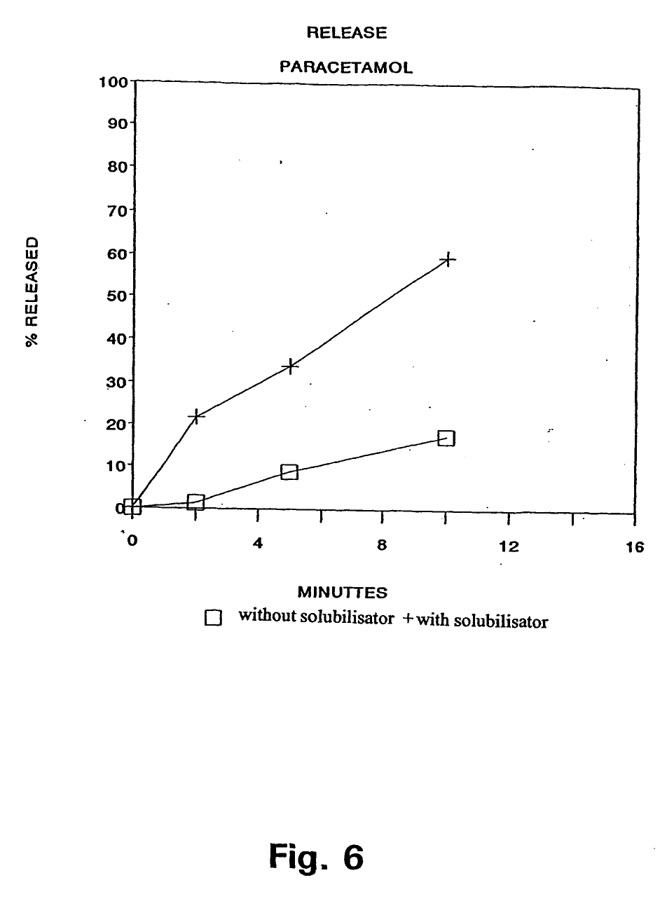

The release process for paracetamol, which is slightly soluble in water (1.4 g/100 ml) is shown in FIG. 6.

Accordingly, due to the availability of a very large number of surface substances, there are great possibilities in order to find the right one which is suitable for the substance which is to be released.

C. Cyclodextrines

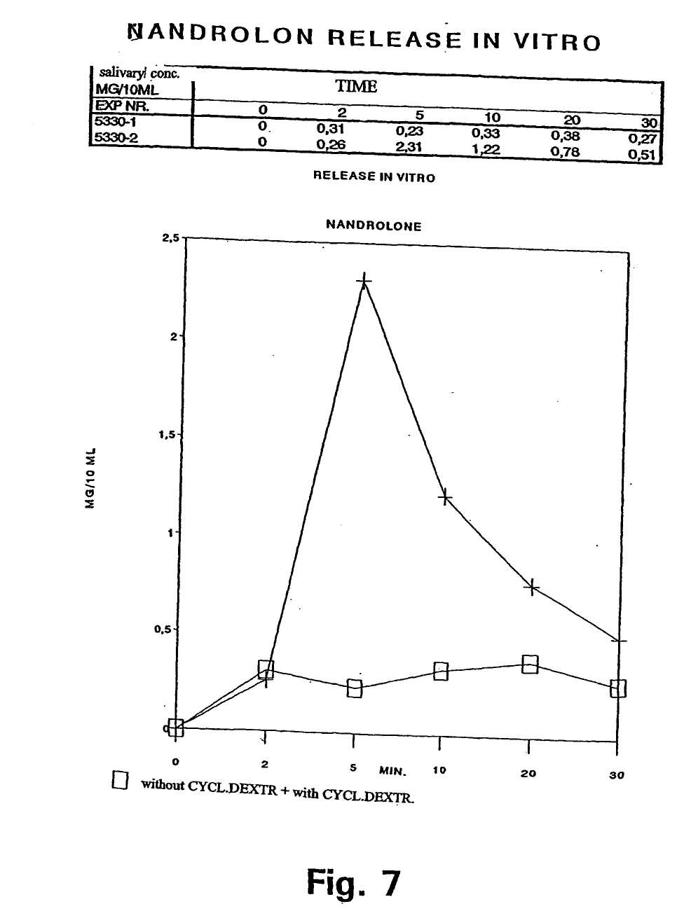

Like solubilizers, cyclodextrines are an obvious possibility to affect the release of medical substances in chewing gum. The release of nandrolone (a heavily soluble compound) with and without cyclodextrin is shown in FIG. 7.

D. Encapsulation

Encapsulation, granulation or other forms of embedding active ingredients in a hydrophilic or hydrophobic matrix to increase or lower the release velocity, is well known in the art. The disadvantages are that these methods usually result in an often complicated production of semi-manufactured goods and the use of specialised apparatus.

The preferred methods according to the invention is:

1) use of a gelatine coated active ingredient (such as A-vitamin) in which a considerable release of the active ingredient vitamin is obtained, even though the active ingredient such as A-vitamin is not water-soluble.

2) use hydrophobic gum base ingredients wherein the active ingredient is embedded.

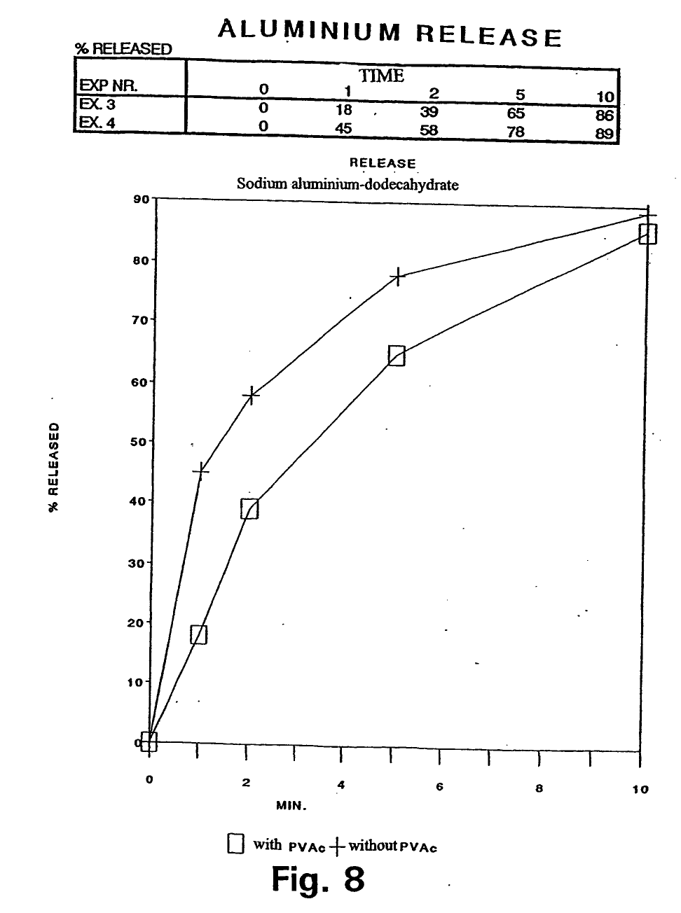

An example of 2) is shown in FIG. 8, in which the release of sodium-aluminium-sulfate dodecahydrate (solubility in water=14 g/100 ml) is compared in two pieces of chewing gum. In one piece, the active ingredient is added directly in the usual way, whereas in the second piece, a polyvinylacetat matrix has been incorporated or intimately mixed with the active ingredient beforehand and then ground.

As it appears, there is a clearly reduced initial release velocity. These results can be expected to improve in case of a further development of this principle.

E. Adherence and Absorption

A known system in connection with nicotine is relatively complicated in that it contains a chewing gum formulation of a very high gum base content, a buffer system which is slowly released during chewing and which ensures a slightly basic medium in the salivary, and finally, the active ingredient nicotine is bound to a ion exchange resin.

Thereby, a relatively stable release of nicotine is obtained on a form which ensures an easy absorption through the mucosal surface of the mouth. Such system is closely correlated to the specific ingredient and cannot be transferred to active ingredients in general.

2.2. Change of the Chewing Gum Formulation

A. Gum Base

The gum base is a central part of the release system. However, trying to modify the hydrophobicity within the frames of prior art and the availability of legally acceptable gum base parts, has only caused very few effects.

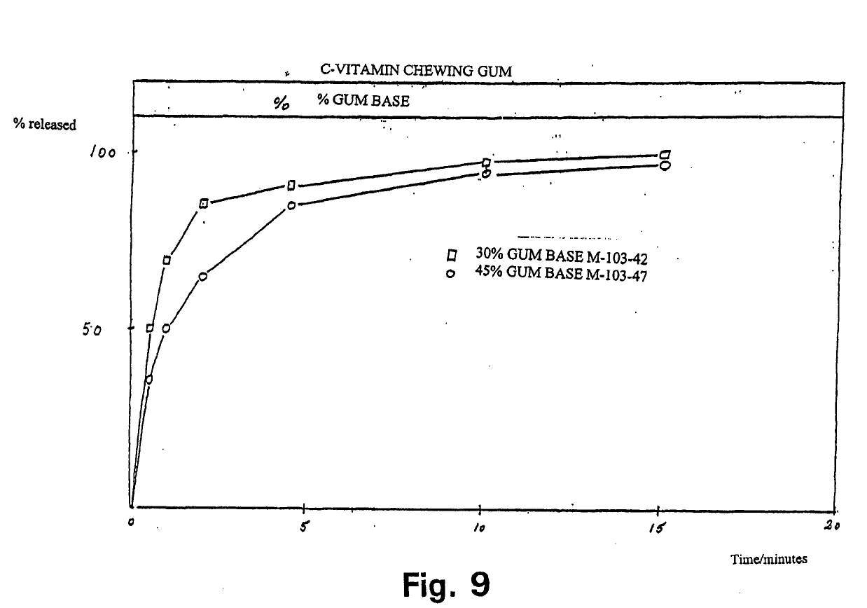

Changing the quantity of gum base due to the expectation that a high content of gum base leads to slow release, and a low content of gum base, leads to quick release (FIG. 9).

2.3. Process Oriented Methods

A. Active Substance in Coat Layer

By adding a slowly releasable active ingredient to the coat layer of a drageed chewing gum, a quick release of the part of the active ingredient is obtained.

However, the result is that just the part which is quickly released, is available since the rest is “captured” by the gum base during the chewing process, where after it will be released slowly.

From a production technical point of view, the method is not very appropriate.

B. Compressed Chewing Gum

This means chewing gum produced by means of the same technology as is used for production of pharmaceutical tablets, but with a gum base content in the form of granulate. By this technique an increase in initial release can be obtained, due to the fact that the active ingredient is not intimately mixed with the dragee layer, like ordinary chewing gum, and thereby a part of the active ingredient is “captured” by the gum base after a short chewing process, and thus it is released very slowly.

C. Time Regulated Processing

A fully analogue result can be obtained by adding a substance which is difficult to release at a late stage in the production process, so that the substance is not heavily mixed with the rest of the contents.

### EXAMPLE 2

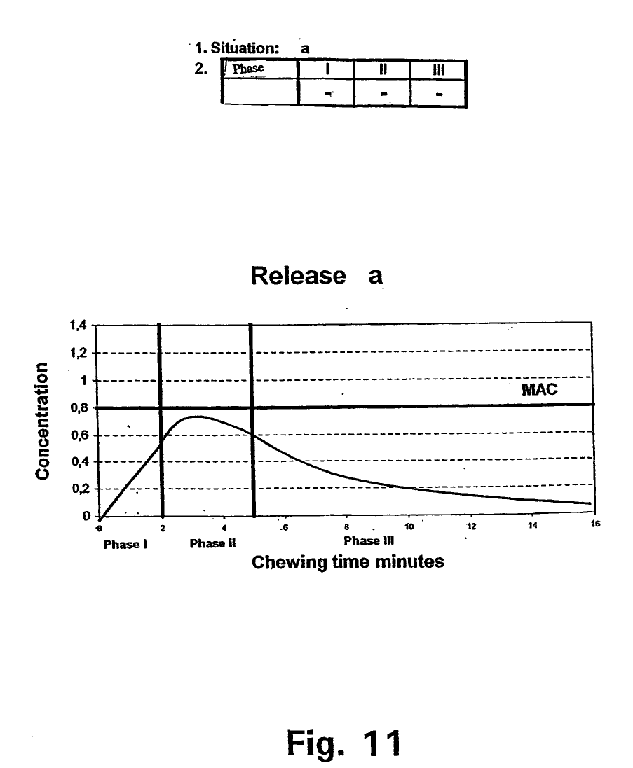

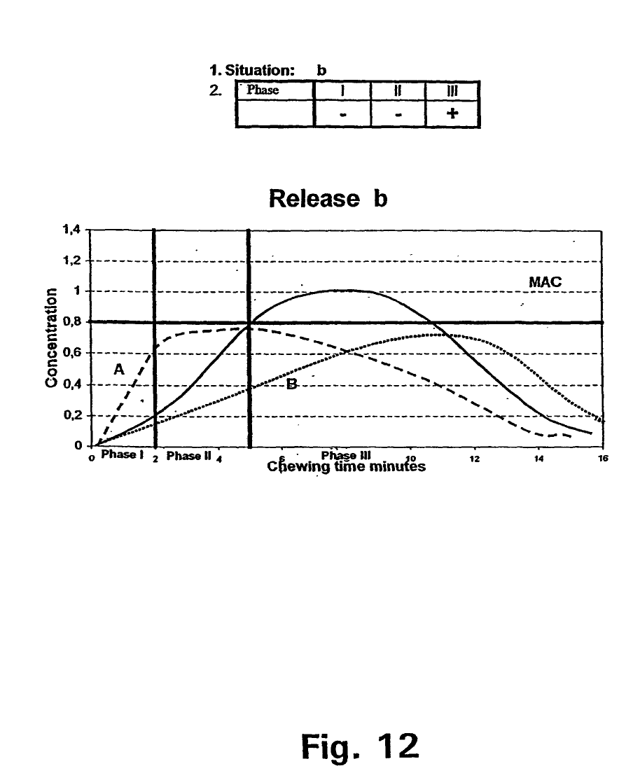

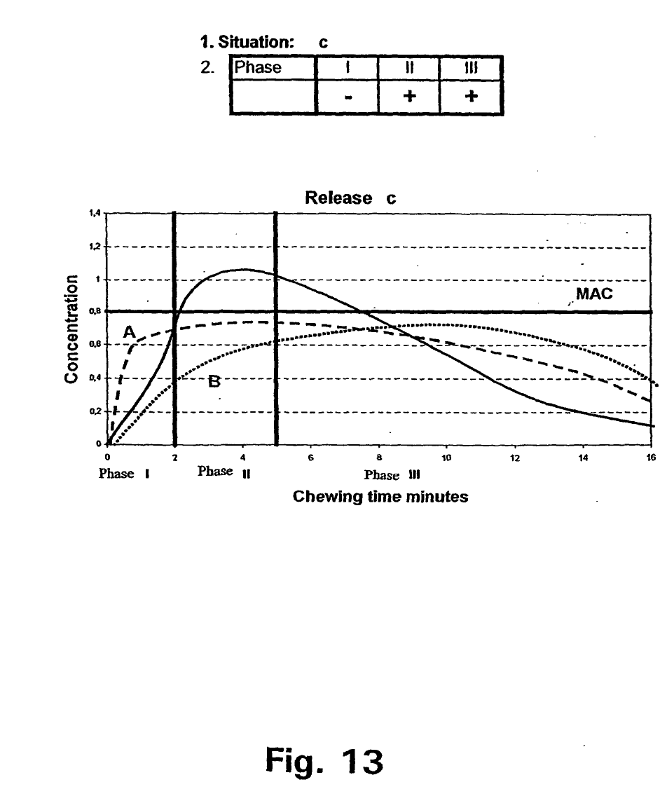

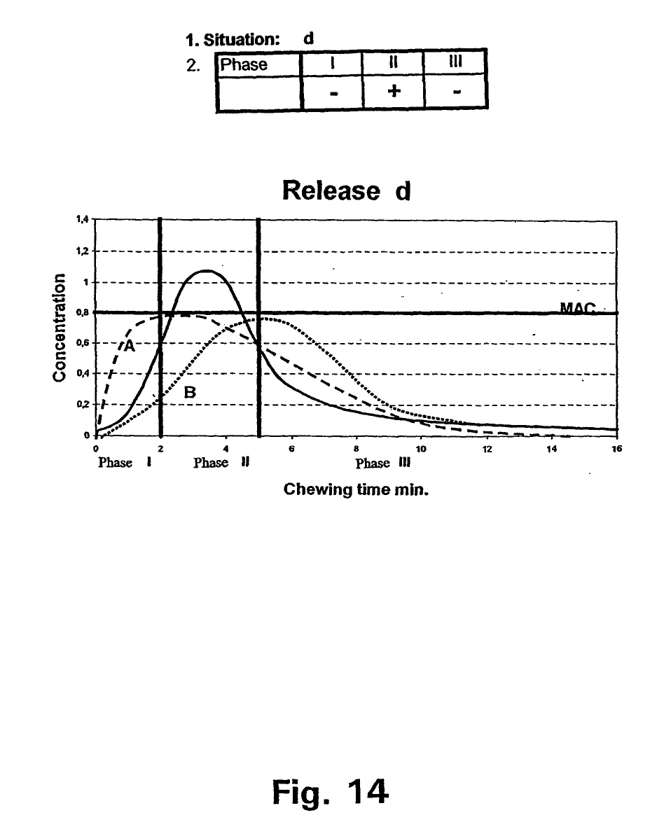

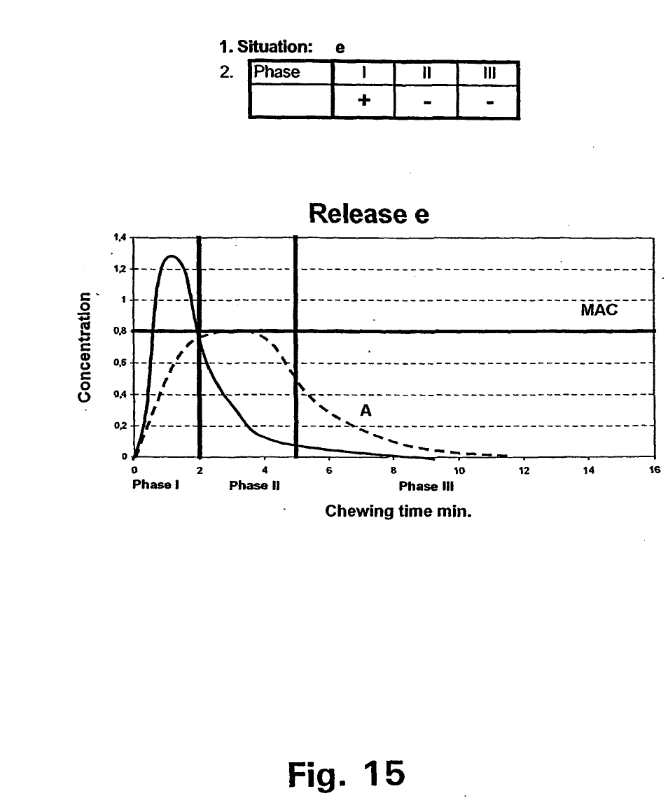

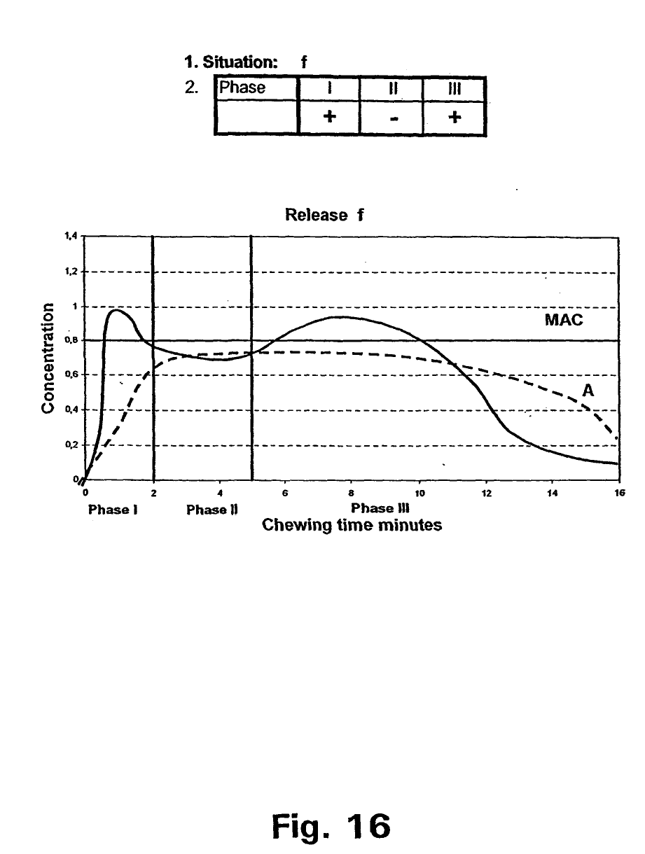

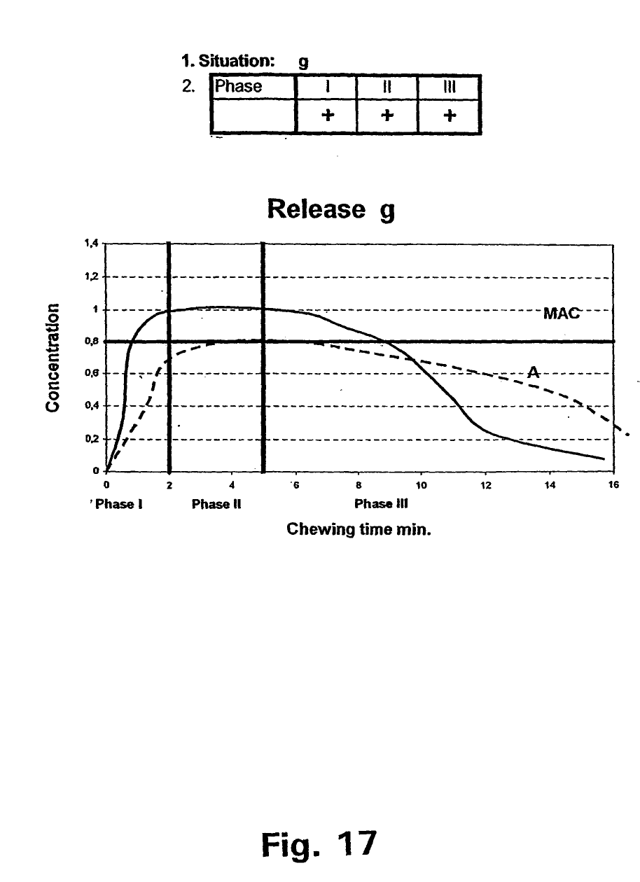

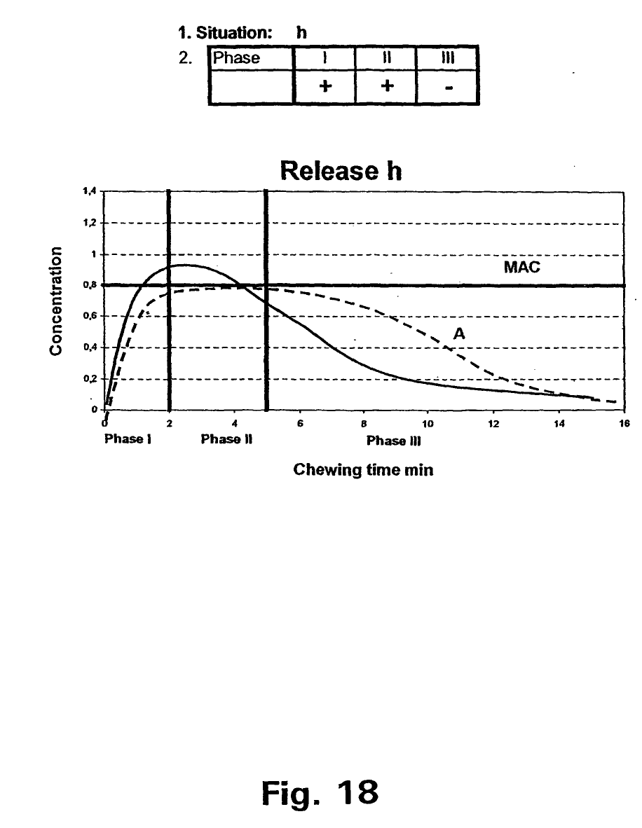

Summary of Situation a to h as Disclosed in FIGS. 11 to 18

Measured concentration of active ingredient indicated in the following phases from the beginning of the chewing period.

| | |
|---|---|
| Phase I | 0-2 min |
| Phase II | 2-5 min |
| Phase III | >5 min |

Definitions Used Herein

| | |
|---|---|
| T: | Threshold value |
| M: | Saturation value |
| MAC: | Maximal Acceptable Concentration |
| AC | Actual concentration |

Situation

| | Phase I | Phase II | Phase III |
|---|---|---|---|
| a. | − | − | − |
| b. | − | − | + |
| c. | − | + | + |
| d. | − | + | − |
| e. | + | − | − |
| f. | + | − | + |
| g. | + | + | + |
| h. | + | + | − |

Situation: b

| Phase | I | II | III |
|---|---|---|---|
| | − | − | + |

Formulation Centre

| Std. | % |
|---|---|
| Gum base | 40 |
| Active ingredient | 2 |
| Flavour | 2 |
| Bulk sweetener | q.s. ad 100 |

Solution A

| | |
|---|---|
| Gum base | 60 |
| Active ingredient | 2 |
| Flavour | 2 |
| Hydrophilic solubilizer | 3 |
| Bulk sweetener | q.s. ad 100 |

Situation: c

| Phase | I | II | III |
|---|---|---|---|
| | − | + | + |

Formulation Centre

| Std. | % |
|---|---|
| Gum base | 35 |
| Active ingredient | 5 |
| Flavour | 2 |
| Bulk sweetener | q.s. ad 100 |

Solution A

| | |
|---|---|
| Gum base | 50 |
| Active ingredient | 5 |
| Flavour | 2 |
| Hydrophilic solubilizer | 3 |
| Bulk sweetener | q.s. ad 100 |

Solution B

| | |
|---|---|
| Gum base | 50 |
| Active ingredient lipophilic encapsulation | 15 |
| Flavour | 2 |
| Bulk sweetener | q.s. ad 100 |

Situation: d

| Phase | I | II | III |
|---|---|---|---|
| | − | + | − |

Formulation Centre

| Std. | % |
|---|---|
| Gum base | 40 |
| Active ingredient | 1 |
| Flavour | 2 |
| Bulk sweetener | q.s. ad 100 |

Solution A

| | |
|---|---|
| Gum base | 50 |
| Active ingredient - hydrophilic encapsulation | 3 |
| Flavour | 2 |
| Bulk sweetener | q.s. ad 100 |

Solution A

| | |
|---|---|
| Gum base | 50 |
| Active ingredient | 3 |
| Hydrophilic solubilizer | 3 |
| Flavour | 2 |
| Bulk sweetener | q.s. ad 100 |

Solution B

| | |
|---|---|
| Gum base | 50 |
| Active ingredient-lipophilic encapsulation | 3 |
| Flavour | 2 |
| Bulk sweetener | q.s. ad 100 |

Situation: e

| Phase | I | II | III |
|---|---|---|---|
| | + | − | − |

Formulation Centre

| Std. | % |
|---|---|
| Gum base | 35 |
| Active ingredient | 10 |
| Flavour | 2 |
| Bulk sweetener | q.s. ad 100 |

Solution A

| | |
|---|---|
| Gum base | 60 |
| Active ingredient | 10 |
| Flavour | 2 |
| Bulk sweetener | q.s. ad 100 |

Solution B

| | |
|---|---|
| Gum base | 35 |
| Active ingredient hydro-phobic encapsulation | 40 |
| Flavour | 2 |
| Bulk sweetener | q.s. ad 100 |

Situation: f

| Phase | I | II | III |
|---|---|---|---|
| | + | − | + |

Formulation Centre

| Std. | % |
|---|---|
| Gum base | 40 |
| Active ingredient | 2 |
| Flavour | 2 |
| Bulk sweetener | q.s. ad 100 |

Solution A

| | |
|---|---|
| Gum base | 60 |
| Active ingredient - hydrophilic encapsulation | 2 |
| Flavour | 2 |
| Bulk sweetener | q.s. ad 100 |

Situation: g

| Phase | I | II | III |
|---|---|---|---|
| | + | + | + |

Formulation Centre

| Std. | % |
|---|---|
| Gum base | 40 |
| Active ingredient | 2 |
| Flavour | 2 |
| Bulk sweetener | q.s. ad 100 |

Solution A

| | |
|---|---|
| Gum base | 60 |
| Active ingredient | 2 |
| Flavour | 2 |
| Bulk sweetener | q.s. ad 100 |

Solution B

| | |
|---|---|
| Gum base | 40 |
| Active ingredient - hydrophilic encapsulation | 10 |
| Flavour | 2 |
| Bulk sweetener | q.s. ad 100 |

Situation: h

| Phase | I | II | III |
|---|---|---|---|
| | + | + | − |

Formulation Centre

| Std. | % |
|---|---|
| Gum base | 35 |
| Active ingredient | 10 |
| Flavour | 2 |
| Bulk sweetener | q.s. ad 100 |

Solution A

| | |
|---|---|
| Gum base | 50 |
| Active ingredient | 10 |
| Flavour | 2 |
| Bulk sweetener | q.s. ad 100 |

### EXAMPLE 3

Test Panel

Determination of Maximal Acceptable Concentration MAC

The determination of MAC is made by a panel of judges, because it is our experience that no good calculation method or artificial (in vitro) methods exist.

The determination is made by implementing a series of dilutions of the substance for the determination of MAC of a number of trained taste experts.

After an initial test on threshold and saturation values of the substance in question, approx. 8 or more judges having neither an extremely high nor a small sensitivity towards the taste of the substance. Thus, judges with very low or high threshold values or saturation values are disregarded.

The saturation and threshold values can be determined according to ISO 3972. In general, the following method is used for the tests:

The tests are performed with the substance dissolved in water at room temperature, but can also be evaluated in other mixtures, with the addition of sweeteners, pH regulating means e.g.

Then, the judges evaluate the substance in a number of diluents either in a falling, increasing or random order. The exact design of the tests will depend upon the nature of the active ingredient, i.e. if it sticks (hangs) in the mouth, creates adaptation or other circumstances.

The judges are instructed to evaluate the taste intensity, i.e. which tests are acceptable and which are unacceptable as regards taste.

On the basis of the evaluations, a MAC is determined indicated by medium value, median, quartile or some other statistical concept.

### REFERENCES

H. P. Fiedler, Lexikon der Hilfstoffe für Pharmacie, Kosmetik und Angrenzende Gebiete, page 63-64 (1981). Martindale, The Extra Pharmacopoeia, 28th edition, page 547-578.

J. Dent.Res. Vol. 28 No. 2, page 160-171, 1949. Pharm. Int., November 1985, pages 267-271, Barney H. Hunter and Robert L. Talbert.

1. Method for preparing a chewing gum with a customer acceptable taste of an active ingredient substantially during all chewing phases, the method comprising
i) testing the taste of the active ingredient in a test system for establishing a maximal acceptable concentration (MAC) of the active ingredient in a liquid formulation,
ii) measuring the release of a desired amount of an active ingredient from a standard chewing gum centre formulation during chewing,
iii) establishing whether the release of ii) results in a concentration exceeding or not exceeding MAC during the chewing period and establishing the time in relation to the chewing period when the concentration is exceeding MAC or is not exceeding MAC, and
iv) adapting the chewing gum formulation to control the release of the active ingredient in the chewing period when the MAC has been exceeded and/or in the chewing period when MAC is not exceeded.

2. A method according to claim 1 wherein the control of the release of the active ingredient in a specific chewing period is adapted by increasing the release of the active ingredient in the chewing period before and/or after the specific chewing period

3. A method according to claim 1 or 2 where the MAC in the specific chewing period has been exceeded.

4. A method according to claim 1 wherein the control of the release of the active ingredient in a specific chewing period is adapted by decreasing the release of the active ingredient in the chewing period before and/or after the specific chewing period.

5. A method according to claim 1 or 4 where the MAC has not been exceeded in the specific chewing period.

6. The method according to any of the preceding claims wherein the time in relation to the chewing period when the MAC has been exceeded or not exceeded is measured as at least a first and second period, preferable as at least a first, second and third period.

7. The method according to claim 6 wherein the first period corresponds to a period within the first 10 minutes from the beginning of chewing, the second period being after the first period and within the period from 1 minute to 20 minutes from the beginning of chewing, a possible third or further period being after the second or third period respectively, and being within the period from 3 to 90 minutes of chewing.

8. The method according to claim 7 wherein the first period corresponds to a period within the first 5 minutes such as the period from 0 to 2 minutes of chewing, the second period being after the first period and within the period from 1 minute to 10 minutes from the beginning of chewing such as from 2 minutes to 5 minutes from the beginning of chewing, a possible third or further period being after the second or third period respectively, and being within the period from 4 to 30 minutes of chewing such as from 5 to 30 minutes from the beginning of chewing, preferable from 5 to 20 minutes of the chewing.

9. The method according to any of the preceding claims wherein it is established whether an increased release in any period is necessary in order not to exceed MAC in any chewing period, and to record the actual period.

10. The method according to any of the preceding claims wherein it is established whether a decreased release in any period is necessary in order not to exceed MAC in any chewing period, and recording the actual period.

11. The method according to any of the preceding claims wherein it is established whether an increased release in any period as well as a decreased release in any other period is necessary in order not to exceed MAC during any of the chewing periods, and to record such periods.

12. The method according to claim 1 wherein it is established that MAC is not exceeded in any period by use of the desired amount of the active ingredient, and where the amount of the active ingredient is subsequently increased in the formulation, if desired.

13. A method according to any of claims 1 to 11 wherein MAC is not exceeded in a first period but in one or more following periods and wherein the chewing gum formulation is subsequently adapted to control the release of the active ingredient in the chewing period when the MAC has been exceeded by one or more of the following adaptations of the chewing gum formulation compared to the standard formulation:
i) increase in the amount of solubilizer and/or use one or more solubilizers having a higher HLB value
ii) increase in the lipophilic character of the active ingredient or of a part of the active ingredient
iii) increase in the amount of gum base and/or increase in the lipophilic/hydrophilic ratio of the gum base
iv) increase in the hydrophilic character of the active ingredient or of a part of the active ingredient.

14. A method according to claim 13 wherein MAC is exceeded in a period followed by a period wherein MAC is not exceeded and wherein the chewing gum formulation is subsequently adapted to control the release of the active ingredient in the chewing period by decreasing the hydrophilic character of the active ingredient or of a part of the active ingredient whereby the concentration of active ingredient is decreased in the former period and increased in one or more of the following periods.

15. A method according to claim 14 wherein the adaptation of the chewing gum formulation is a combination of
iii) an increase in the amount of gum base and/or increasing the lipophilic/hydrophilic ratio of the gum base; and
iv) an increase in the hydrophilic character of the active ingredient or of a part of the active ingredient in order to increase the release in the first period and decrease the release in the period wherein the MAC was exceeded prior to the adaptation.

16. A method according to claim 14 wherein the adaptation of the chewing gum formulation is a combination of
i) an increase in the amount of solubilizer and/or use of one or more solubilizers having a higher HLB value, and
ii) increase in the amount of gum base and/or increase in the lipophilic/hydrophilic ratio of the gum base
in order to increase the release in the first period and decrease the release in the period wherein the MAC was exceeded prior to the adaptation.

17. A method according to claim 14 wherein the adaptation of the chewing gum formulation is a combination of
i) an increase in the lipophilic character of the active ingredient or of a part of the active ingredient and
ii) an increase in the amount of gum base and/or an increase in the lipophilic/hydrophilic ratio of the gum base
in order to decrease the release in the period wherein the MAC was exceeded prior to the adaptation and to increase the release in a subsequent period.

18. A method according to any of claims 1-11 wherein MAC is exceeded in a period followed by a period wherein MAC is not exceeded and wherein the chewing gum formulation is subsequently adapted to control the release of the active ingredient in the chewing period by increasing the hydrophilic character of the active ingredient or of a part of the active ingredient, whereby the concentration of active ingredient is decreased in the former period and increased in one or more of the following periods.

19. A method according to any of claims 1 to 11 wherein MAC is exceeded in a first period, but not in one or more of the following periods, and wherein the chewing gum formulation is subsequently adapted to control the release of the acfive ingredient in the chewing period when the MAC has been exceeded by one or more of the following adaptations of the chewing gum formulation compared to the standard formulation:
i) increase in the lipophilic character of the active ingredient or of a part of the active ingredient
ii) increase in the amount of gum base and/or increase in the lipophilic/hydrophilic ratio of the gum base.

20. A method according to claim 19 wherein the MAC is exceeded in a first period, but not in a second period and MAC is exceeded in a subsequent third period, and wherein the chewing gum formulation is subsequently adapted to control the release of the active ingredient in the chewing periods when the MAC has been exceeded by one or more of the following adaptations of the chewing gum formulation compared to the standard formulation:
i) increase in the lipophilic character of the active ingredient or of a part of the active ingredient
ii) increase in the amount of gum base and/or increase in the lipophilic/hydrophilic ratio of the gum base
whereby the release is decreased in the first periods, increased in a second period, decreased in a third period, and optionally increased in a period following the third period.

21. A method according to any of claims 1-11 wherein the MAC is exceeded in each of the periods recorded, and wherein the chewing gum formulation is subsequently adapted to prolonged the total release period of the active ingredient in order to decrease the release in the chewing periods when the MAC has been exceeded by one or more of the following adaptations of the chewing gum formulation compared to the standard formulation:
i) increase in the lipophilic character of the active ingredient or of a part of the active ingredient
ii) increase in the amount of gum base and/or increase in the lipophilic/hydrophilic ratio of the gum base.

22. The method according to any of the preceding claims
wherein the standard chewing gum formulation comprises
i) gum base 15-99% w/w
ii) active ingredient 0.001-75%/w/w
iii) optionally up to 5% w/w flavour
iv) optionally one or mere high potent sweeteners 0.01-5% w/w
v) optionally one or more solubilizers
vi) bulk sweetener q.s ad 100% w/w

23. The method according to any of the preceding claims wherein the test system is a test panel with at least one test person.

24. The method according to any of the preceding claims wherein the test system includes a panel of test persons for identifying MAC and which thereby represents the customer acceptable taste of the active ingredient.

25. The method according to any of the preceding claims wherein the MAC is defined as a percentage of the average of the acceptable concentration measured in the test system.

26. The method according to any of the preceding claims wherein the measuring of the release of the active ingredient from a standard chewing gum formulation during chewing is performed in a chewing machine.

27. The method according to any of claims 1-25 wherein the measuring of the release of the active ingredient from a standard chewing gum formulation during chewing is performed by one or more test persons.

28. The method according to any of the preceding claims wherein the complete chewing period is measured in 90 minutes from the start of the chewing, preferably for 60 minutes such as for 45 minutes.

29. The method according to any of the preceding claims wherein the complete chewing period is measured in 40 minutes from the start of the chewing, preferably for 35 minutes such as for 30 minutes.

30. The method according to any of the preceding claims wherein the complete chewing period is measured in 25 minutes from the start of the chewing, preferably for 20 minutes such as for 15 minutes.

31. The method according to any of the preceding claims wherein the complete chewing period is divided in at least 2 periods such as at least 3 periods.

32. The method according to any of the preceding claims wherein the increase in the amount of solubilizer is at least 2% w/w such as at least 5% w/w.

33. The method according to any of the preceding claims wherein the increase in the lipophilic character of the active ingredient or of a part of the active ingredient is by the use of a lipophilic coating of the ingredient.

34. The method according to any of the preceding claims wherein the increase in the amount of gum base is at least 2% w/w such as at least 5% w/w.

35. Th method according to any of the preceding claims wherein the increase in the hydrophilic character of the active ingredient or of a part of the active ingredient is by encapsulation of the ingredient with a hydrophilic component.

36. The method according to claim 35 wherein the encapsulation with a hydrophilic component is used in combination with an increase in the gum base, and where the increase in the gum base is performed in order to decrease the release in a first period and the encapsulation counteract the resulting increase in the release in a later period.

37. The method according to any of the preceding claims for the preparation of a chewing gum comprising an effective amount of an active ingredient and having a substantially constant release of the active ingredient in all chewing phases or periods and wherein the MAC is not exceeded in any of the chewing periods or phases.

38. The method according to any of claims 1-38 for the preparation of a chewing gum comprising an effective amount of an active ingredient, and having a relative fast release of the active ingredient in the first chewing phase or period and wherein the MAC is not exceeded in any of the chewing periods or phases.

39. The method according to any of the preceding claims wherein the chewing gum formulation is coated.

40. The method according to any of the preceding claims wherein the active ingredient is further present in the coating of the chewing gum formulation.
